(19) United States
(12) Patent Application Publication
(10) Pub. No.: US 2006/0212545 A1
(43) Pub. Date: Sep. 21, 2006

(54) Private Network Exchange With Multiple Service Providers, Having a Portal, Collaborative Applications, and a Directory Service

(75) Inventors: Jeffrey Nichols, Cattlesburg, KY (US); Rebecca Lewis, San Diego, CA (US)

Correspondence Address: BANNER & WITCOFF, 1001 G STREET N W, SUITE 1100, WASHINGTON, DC, 20001, US

(73) Assignee: SCIENCE APPLICATIONS INTERNATIONAL CORPORATION, San Diego, CA (US)

(21) Appl. No.: 11/381,933

(22) Filed: May 5, 2006

Related U.S. Application Data
(62) Division of application No. 09/900,458, filed on Jul. 9, 2001.
(60) Provisional application No. 60/216,886, filed on Jul. 7, 2000.

(51) Int. Cl. G06F 15/16; G06Q 99/00; H04L 9/00; H04K 1/00

(52) U.S. Cl. 709/219; 705/78

(57) ABSTRACT

A private network exchange with multiple service providers, having a portal, collaborative applications, and a directory service is provided. The private network exchange can operate across multiple service providers, and provides a minimum service level regardless of the service providers involved. The Portal provides a user friendly interface to present the collaborative applications and directory service. The collaborative applications allow users to work together in a secure manner. The directory service presents users with a way to search the network.

### RELATED APPLICATIONS

This application is a divisional of U.S. application Ser. No. 09/900,458, filed on Jul. 9, 2001, which claims priority from and bodily incorporates the subject matter of previously filed provisional U.S. application Ser. No. 60/216,886, filed Jul. 7, 2000, the content of which is hereby incorporated by reference in its entirety.

### BACKGROUND OF THE INVENTION

1. Field of the Invention

The present invention relates to a private network exchange with multiple service providers, having a portal, collaborative applications, and a directory service. More particularly, the present invention is directed to a portal, collaborative applications and directory service for use in a private network exchange.

2. Description of the Prior Art

Virtual private networks (VPN) have been developed to provide a higher level of security than is available on public networks such as the Internet. A VPN is basically a way to create a logical tunnel from one end point to another. Conventional virtual private networks are generally not interoperable across service providers and/or across IPsec gateways.

However, conventional VPNs cannot communicate across multiple service providers, and do not provide a minimum service level to the users.

The Advanced Network eXchange, or ANX, is a managed network service for e-business. It was designed in 1996-1997, and brought into operations in 1998. As of spring 2000 over 400 companies, primarily in the automobile industry, use the ANX service.

The current ANX evolved from the Automotive Network eXchange (ANX), chartered by the Automotive Industry Action Group (AIAG) to support secure electronic trade within the automotive industry. In 1994, the AIAG defined and published the AIAG document Trading Partner Data Telecommunications Protocol Position, which recommended the network protocol TCP/IP (Transmission Control Protocol/Internet Protocol) as the standard for transport of trading partner electronic information. In 1995, Chrysler, Ford and GM endorsed TCP/IP as the standard protocol suite for inter-enterprise data communications among trading partners. Subsequently, the AIAG's Implementation Task Force (TTF), composed of representatives of the Big Three automakers and several major Tier One suppliers, developed the concept of a TCP/IP network for all trading partner—the Automotive Network eXchange® Network. The ANX® Network that grew out of this recommendation now provides trading partners with a single, secure, quality network for electronic commerce and data transfer to support the automotive supply chain.

In December 1999, the AIAG agreed to sell its ANX assets and operations to SAIC. In May 2000, SAIC launched ANXeBusiness, a wholly-owned subsidiary chartered to build upon the ANX assets and create a world-class B2B service utility.

### SUMMARY OF THE INVENTION

The deficiencies of the conventional systems and methods are addressed by the present invention that is directed to a private network exchange with multiple service providers, having a portal, collaborative applications, and a directory service.

An advantage of the private network exchange with multiple service providers, having a portal, collaborative applications, and a directory service of the present invention is that it can operate across multiple service providers.

Another advantage of the private network exchange with multiple service providers, having a portal, collaborative applications, and a directory service according to the present invention is that a minimum service level is provided regardless of the service providers involved.

Yet another advantage of the private network exchange with multiple service providers, having a portal, collaborative applications, and a directory service according to the present invention is that a user friendly interface is provided.

Still another advantage of the private network exchange with multiple service providers, having a portal, collaborative applications, and a directory service according to the present invention is that access to the network can be strictly controlled.

Another advantage of the private network exchange with multiple service providers, having a portal, collaborative applications, and a directory service according to the present invention is that cooperative capabilities are provided so that users at various companies can take advantage of the network.

### BRIEF DESCRIPTION OF THE DRAWINGS

These and other attributes of the present invention will be described with respect to the following drawings in which:

FIG. 1 is a block diagram of the system according to the present invention;

FIG. 2 is a block diagram of the ANX Extranet services according to the present invention;

FIG. 3 is a flow chart or the process of creating a new ANX account according to the present invention;

FIG. 4 is a flow chart of the process of activating a new account according to the present invention;

FIG. 5 is a flow chart of the process of de-activating a new account according to the present invention;

FIG. 6 is a flow chart of the process of updating a user profile according to the present invention;

FIG. 7 is a flow chart of the process of managing a company's Points of Contact, according to the present invention;

FIG. 8 is a flow chart of the process of importing directory services according to the present invention;

FIG. 9 is a flow chart of the process of resetting passwords according to the present invention;

FIG. 10 is a screen of the ANX Portal home page according to the present invention;

FIGS. 11-15 are screens of the ANX Directory Services according to the present invention;

FIG. 16 is a screen of the document repository according to the present invention;

FIG. 17 is a screen of the document forwarding feature according to the present invention;

FIG. 18 is a screen of the e-mail feature according to the present invention;

FIG. 19 is a screen of the community services feature according to the present invention;

FIG. 20 is a screen of the training feature according to the present invention;

FIGS. 21-23 are screens of the industry news feature according to the present invention;

FIGS. 24 and 25 are screens of a product showcase feature according to the present invention;

FIGS. 26 and 27 are screens of the calendar feature according to the present invention; and

FIG. 28 is a screen of the service provider certification feature according to the present invention.

### DETAILED DESCRIPTION OF THE INVENTION

The ANX embodies several basic concepts. The ANX is a provider of network-level security and high quality data transport service originally primarily for the automotive industry. However, the ANX is not the Internet, though it is constructed using the Internet Protocols. The ANX is built on an open, multi-provider competitive model that allows any certified vendor to provide transport services—it is not proprietary. The ANX is a facilitator for e-business and business re-engineering.

The following are definitions of terms used herein:
ADA: ANX Directory Administrator is the designated person in the ANX Overseer organization who will initially configure the trading partners information in the ANX Directory.
AEDA: ANX Enterprise Directory Administrator is the designated person in the Trading Partner organization who will authenticate and approve new user registrations and manage existing users for the ANX Portal and designate other points of contact (POC) for the company.
AEDDA: ANX Enterprise Division Directory Administrator is the designated person in the specified division of the Trading Partner organization who will authenticate and approve new user registrations and manage existing users associated with that specific division for the ANX Portal and designate other points of contact (POC) for the specified division.

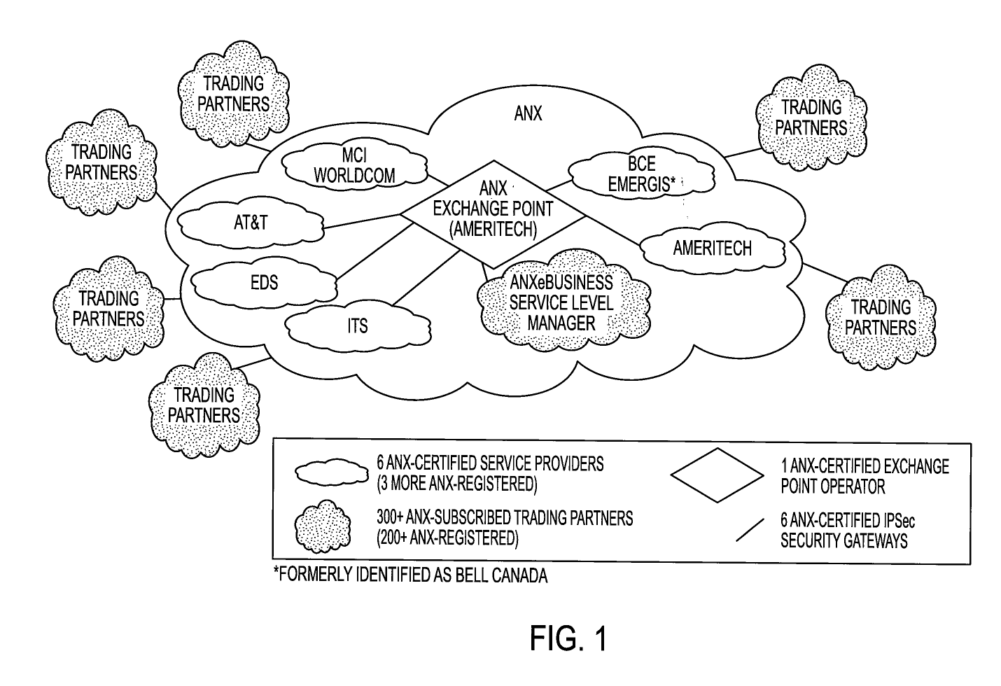

FIG. 1 depicts the ANX network 50. More than 400 trading partners 52 use the ANX services through interconnected ANX Certified Service Providers (CSPs) 54. These CSPs 54 are certified and managed by the ANX Operations (ANXO) in accordance with the TEL-2 Release 1 specification. At least six ANX CSPs 54 have been certified: Ameritech, AT&T, BCE Emergis, EDS, Ideal Technology Solutions, and MCI WorldCom. TEL-2 specifies the service level agreement (SLA) between ANX 50 and the CSPs 54.

A trading partner 52 connects to an ANX CSP 54 through a standard data access service, such as a T1 line or DSL line. ANX Trading partners connect to each other via secured TCP/IP tunnels constructed by agreement between two IPSec gateways-one at each end of the tunnel, in the trading partner 52 premises. These IPSec gateways provide encryption-based mutual authentication and confidentiality using a secret key shared between the two communicating parties. Each trading partner 52 selects a gateway product from among at least seven vendors: Axent, Checkpoint, Cisco, IRE, Network Associates, Nortel, RadGuard, and Timestep. Gateway products are certified by the ANXO based on International Computer Security Association (ICSA) efforts and other ANX specified criteria.

Trading partners 52 who subscribe to the same CSP 54 may trade within the CSP's subscriber domain. However, if a trading partner 52 who subscribes to CSP “A” wishes to trade with a trading partner 52 who uses CSP “B,” their transaction is switched by an ANX Certified Exchange Point 56 Operator (CEPO), also certified by the ANXO. AS of July 2000, the only CEPO was Ameritech. The CSP-CSP Exchange Point 56 is based on asynchronous transfer mode (ATM). The ANX network 50 is isolated from the Internet-though access to ANX services and the Internet comes together inside trading partner networks 52, using a variety of firewall/gateway architectures.

ANX Managed Transport Service.

The ANX Managed Transport Service (MTS) is a modified version of an original 1996-1997 design. It is an IP transport service, delivered via a unique multi-provider architecture. The current MTS has many features and benefits. It embodies most of the original design goals expressed by the automotive community circa 1996. These features include:
a. The ability for a customer to purchase ANX transport services from any of several leading transport providers.
b. The ability for a customer to purchase any of several certified IPSec gateway devices.
c. Guaranteed interoperability of ANX virtual private network (VPN) services across multiple transport providers and gateway devices.
d. A common service quality across multiple providers—where service quality has the dimensions of network latency, availability, interoperability, security, and customer support.
e. Significantly greater gateway-gateway security than is available on Internet infrastructure—comparable to that of private point-point network links between business partners.
f. Ongoing service additions/improvements, including an expanded geographic “footprint” and enabling additional traffic types—e.g., voice and video traffic.

Referring to FIG. 1, at the outside edge are the trading partners 52, which are the same as customers, and are generally companies, and each cloud 52 represents a companies' intranet. Each trading partner cloud 52 is a representation of their entire intranet, which can include wide and local area networks for that company. There is an access 51 line between the trading partner cloud and a bigger cloud labeled ANX 50. The access line 51 has two end points. The end point on the trading partner's side is called the ANX gateway, and is a router or a peer gateway that is compatible with the protocol family IPsec. There are approximately seven or eight companies, which are presently certified, and thus they are interoperable with each other. Specialized devices, such as a Cisco 2500 series router or an Accent Raptor gateway, are devices that have been certified for use on ANX system, meaning it will be interoperable with all of the other ANX certified devices or gateway devices.

The specialized devices sit in the customers premises, typically attached to a firewall where the firewall provides insulation of ANX 50 and the trading partners own intranet 52 from the Internet. The Internet is not shown in FIG. 1. The Internet is a logically separate network from ANX 50. The access line 51, or the access network, can be any typical access technology that is T1, T3, leased line of 56 kilobit, or it can be any bandwidth with leased line, fractional T1, and can be a dial or a DSL connection.

Between the trading partner premises equipment, i.e. the IPsec gateway at the trading partners 52, there is a link back to an access point at the presence of any one of the certified data service providers. Data service providers are represented in FIG. 1, by the smaller clouds 54, and may include companies such as AT&T, MCI WorldCom, Ameritech, BCE Emergis, EDS, and ITS. The provision of certified service providers 54 is fundamental to how the ANX network works. Each of the certified service providers 54 has gone through a certification program. The certification process and its certification metrics are defined the Tel 2 document, which is the document that governs how this architecture works.

The certification process defines the steps that a certified service provider, such as AT&T, has to go through to become a certified provider. One of the steps in the process is aimed at guaranteeing that the certified service provider 54 can satisfy a service metric called latency. In the ANX network 50, the latency requirement is: across any single service provider cloud 54 a packet shall take no more than 125 milliseconds to cross that cloud. Therefore, a step in the process is to prove that the service provider can meet that metric.

A unique aspect of the ANX network 50 is that the specifications and the processes behind the ANX managed transport network define the way that service providers 54 interoperate with no visibility to the end customers, i.e., trading partners 52. For example, an ANX trading partner 52 can buy ANX service from one service provider 54, such as AT&T, and another trading partner 52 can buy ANX service from a different service provider 54, such as Ameritech, and those two trading partners can have data communications that are interoperable. The communication between the trading partners is interoperable at several levels. The communication is interoperable at the fundamental packet passing level, and is interoperable in terms of virtual private networks.

A virtual private network (VPN) is basically a way to create a logical tunnel from one end point to another, and conventional virtual private networks are generally not interoperable across service providers and/or across IPsec gateways. In the ANX network 50, interoperability among certified providers 54 and components is an advance over existing virtual private networks.

The ANX network 50 does not manage the certified service provider's network 54. Rather, the ANX network 50 sets a specification, and the certified service providers 54 agree to provide service meeting minimum requirements with regard to customer service response time, packet latency, availability of a network service, etc. as set forth in the Tel 2 specification. There are remedies specified in the Tel 2 specification, for when that service level is not delivered, and the remedies ultimately result in de-certification.

The next element is the Exchange Point 56. The exchange point 56 is a creative way to perform network peering. Within the network provider cloud, the ANX network 50 does not care what technology is used to deliver the packets across the service provider cloud 54. A packet goes from one service provider to another through the Exchange Point 56, which is specified to be an ATM, an Asynchronous Transfer Mode switch. Each service provider 54, as part of the process of becoming certified must buy and maintain a DS3, which is a 45-megabit line from their cloud (their data network) to the Exchange Point 56. Ameritech may be licensed to operate the Exchange Point, and Ameritech may then set up permanent virtual circuits (PVCs), on top of the ATM switch, linking each of the service providers 54 with every other service provider 54. Every service provider 54 is connected by an ATM based PVC to every other service provider 54 and Ameritech operates the Exchange Point 56 with another set of service metrics including the Exchange Point's availability, the Exchange Point's switching time, etc.

Another part of the Tel 2 specification specifies that no trading partner 52 to trading partner 52 interaction shall require more than two certified service provider 54 (CSP) hops, as shown in FIG. 1. If the trading partner 52 connected to the Ameritech CSP cloud 54 wants to talk to the trading partner 52 connected to EDS CSP cloud 54, the packet leaves the trading partner 52, traverses the Ameritech cloud, the Exchange Point 56, the EDS cloud, and then onto it's destination, thus completing no more than two hops. That is part of the way the ANX network guarantees end-to-end performance, where the end points are the IPsec gateways at the customer premises. Across any CSP cloud 54 the specification requires a maximum of 125 milliseconds. Across any two clouds, which in theory is the entire distance across the ANX network 50, the specification requires a maximum of 250 milliseconds. An assumption is that the Exchange Point 56 has effectively zero latency.

Turning to the cloud 58 labeled ANXeBusiness Service Level Manager, in FIG. 1, this cloud 58 is a small server complex and router firewall complex that allows monitoring of the network 50 via the transmission of a packet across the network and measurement of it's transit time, and some lightweight monitoring and management of things.

The ANX network managers, have the ability to measure randomly most of the performance characteristics of the service providers' networks 54. The ANX managers can see if the service providers 54 are available, if their data service is actually available at a random moment in time. The managers can also send a packet across a single service provider cloud 54 or multiple service provider clouds 54, and measure the latency. Operations can also attempt to send a packet on through trading partners 52 and so on. The ANX operations cloud 58 represents a very small set of servers with a very lightweight set of measuring and monitoring applications.

Options and Preferences

Starting at a trading partner 52 again, each gateway must be configured, but the Tel 2 specification does not say how it must be configured. The trading partners 52 are free to configure their gateways as they see fit because the gateway is nothing more than a device which can supply a security policy to IP packets, and each trading partner 52 has it's own security policy, and there are certain things that the trading partner 52 must do in order to have a logical connection to the ANX network 50. For example the trading partner 52 must allow traffic to pass from an application or from their network or intranet on through this device to the ANX network 50 and vice/versa. There is also an option in the access line. The access lines between the trading partner 52 and the service provider 54 can be almost anything again 56 kilobit lease lines, T1, DSL Dial services, T3s, etc. The trading partner 52 has the choice of which of the certified service providers 54 they buy the data access services from. What the trading partners 52 actually buy is an access line of a given bandwidth. The trading partners 52 also buy the IPsec gateways. The trading partners 52 can buy management services of the IPsec gateway from anyone of several companies.

In existing conventional VPNs, if a company C has data services provided from the same service provider as other companies that have set up a VPN, company C could be added to the original virtual private network with very little trouble. If company C was a consumer or purchaser of data services from some other service provider, and wanted to join the VPN that was administered by a different service provider for the existing VPN, then one group or the other would have to switch providers because there is no VPN interoperability or peering typical in the industry today.

In the ANX network 50, once a trading partner 52 buys an access line from one of the certified service providers 54, that trading partner 52 can then create VPNs at will, with any other company who is an ANX trading partner 52. The only two participants in that transaction are the two trading partners 52. The service providers 54 themselves need not be involved. On the other hand, in the conventional single provider VPN case, the server providers themselves must be involved.

Previously, it was generally accepted that no data communication between two trading partners 52 should take place over the ANX network 50 except through IPsec tunnels. Consequently, if a trading partner 52 were going to have any data communication across the ANX network 50 to any other trading partner 52, a point-to-point tunnel had to be constructed, and then that communication had to take place through that tunnel, another word for virtual private network (VPN). That was the generally accepted policy. In the present system, to be a subscriber to the ANX network 50 a trading partner 52 must purchase and have the ability to construct an IPsec tunnel between themselves and any other trading partner 52 on the ANX network 50. IPsec tunneling in the form of a VPN is a very strong security mechanism. Therefore, any communication between two trading partners 52 across the ANX network 50 can take place using any security mechanism any two trading partners 52 deem appropriate including none. The use of tunnels is not necessary to practice the technology; it is just a matter of security rather than matter of technical necessity.

The use of tunnels or any other VPN technology is not required to move a packet from one trading partner 52 to another. The IP protocols and IP transport layers, and then the ATM in the middle performs that function. The use of VPN technology, as embodied by IPsec tunnels, is the preferred method of protecting information and privacy from a subset of the ANX network community. For example, for a business process a trading partner 52 may only want one other party to that process on the ANX network 50. The trading partner 52 then constructs a tunnel to the other trading partner 52, and no other trading partner 52 on the ANX network 50 can participate in that process, and no other trading partner 52 or network manager can see the data, if the data is encrypted. The ANX network 50 provides the tools, which at the network level are the IPsec family of protocols that cover many things, including the encryption, and multiple ways to do the encryption.

However, when trading partners 52 decide to create a tunnel they have to agree on several things. They have to share their network addresses. The two trading partners 52 have to configure their IPsec devices, which actually implement the tunnels agreeing on the encryption method, for example whether it's no encryption or triple DES. A variety of encryption algorithms are supported within IPsec.

In the foregoing ANX network 50 services, all that is being provided is transport and the ability to create secure communications through tunnels. Certification that a transport will work to certain metrics and that tunnel creating facilities are interoperable and everyone has them are provided. A trading partner 52 is free to put whatever applications they desire on the network. The trading partner 52 must configure their gateway, their firewall and their routing and DNS services as needed, but the trading partner 52 has to configure their network services to allow other trading partners 52 on the ANX network 54, either all of the trading partners 52 or a select set of trading partners 52 to have data access to some application that lives inside their intranet. So any application, websites, client server applications, SAP, and any kind of an application in any architecture so long as it works using the IP protocols can be made available through the ANX network 50. The only protocol the ANX network 50 supports is IP. If a trading partner 52 is going to do anything else it has to be encapsulated, which is a very common technique. Two trading partners 52 can use the ANX network 50 to swap data by sending CAD files back and forth, or they could use the ANX network 50 as a secure dependable vast e-mail conduit, or they could put up websites that display an online catalog. Those websites could be made viewable to any other ANX subscriber 52 or to just one.

ANX Extranet Services

Extranet Services are the first realization of an aspect of the new ANX managed services incorporated in the present invention. ANX Extranet Services went into production in June-July 2000. With the advent of these services, ANX 50 is the first multi-provider extranet services provider, or ESP.

The three major components of ANX Extranet Services are:
a. A 13213 Directory Service,
b. A PKI Service (Public Key Infrastructure), and
c. A new 13213 website, termed “the ANX Portal”.

The ANX Directory Service (DS) is a new use of traditional open-architecture directory services. The ANX DS is based on Netscape's LDAP Server, which is a very scalable product, i.e. it can support millions of directory entries. The new use, according to the present invention, is that the ANX DS resides solely in the extranet space, as opposed to the typical use as a corporate directory or metadirectory. The ANX DS contains organizational, people, security, and place information for thousands of companies, and is accessed by employees and applications in those diverse companies, subject to application of the security policy of ANX customers. The ANX DS supports ebusiness's needs for new kinds of information retrieval, such as:
a. Who are all the purchasing agents in a particular on-line community?
b. What are their email addresses?
c. Where are all the service locations of company X?
d. Who are all the companies associated with product or project Y?
e. What companies are registered with SIC?

The ANX DS is a powerful tool for businesses on the ANX network 50. Rapid, authoritative access to location and identification information is crucial to the creation of efficient on-line commerce processes. To date, no such business-to-business (B2B) DS exists on the Internet or elsewhere. With regard to operations/management for the ANX DS, the model is a self-administered model, where the customers establish a registration/use policy, and individual employees enter information into the DS as per that policy.

The ANX PKI Service is aimed at automating the authentication and secret-key exchange processes between trading partners. It also is used for user authentication and digital signatures. Previously, authentication and key exchange on ANX were done using passwords to enable network administrators to communicate and manage secret encryption keys, which were then used to establish the VPN (virtual private network) connections used on ANX. The new PKI Service automates the process of gate-gate authentication and key exchange via digital certificates, and takes much of the management overhead out of the process. PKI may be implemented at the user level to strengthen the user authentication process and to enable digital signatures for non-repudiation of business transactions.

The ANX PKI Service is based on the Verisign security products. This service went into production in July 2000.

The ANX Portal is the gateway into ANX managed services. The Portal enables individuals to register as ANX users and provides a number of information and application services designed to foster community interaction. The Portal is built on a Sun/Netscape platform, and is extremely scalable, i.e. capable of supporting tens of thousands of users.

The ANX Portal's main functions include:
a. Providing a place to register as an ANX user.
b. An information resource for content specific to an industry, or to a cross-industry community of interest.
c. A collaboration space for users and communities. The Portal has features to support collaborative work-document sharing and storage, and messaging, for example.
d. A registration interface for the Directory Service.
e. A pointer to applications integrated into the ANX network.
f. A way for ANXeBusiness or ANX customers to promote their services within the various online communities.

Process Integration Through ANX Extranet Services

The one way to illustrate the power of the combined Extranet Services is through an example of a fully-integrated process employing all the components.

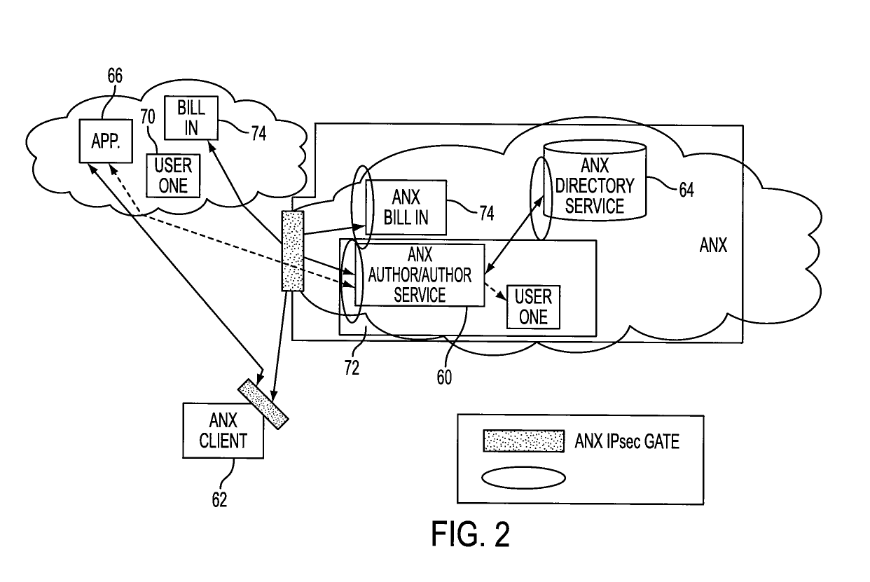

FIG. 2 depicts the authentication/authorization interaction for a scenario where a trading partner's application(s) make use of the ANX PKI, Portal and DS Services. The user 70 logs into the ANX Portal 72 using the ANX Authentication Service 60 and a personal private key, using the Secure Sockets Layer (SSL) protocol. SSL mutually authenticates the server and the client 62. The Authentication Service 60 checks the user's profile (distinguished name, service authorizations, groups) in the Directory Service (DS) 64 and generates a user object (“authorization ticket”) to be used by ANX applications. Once the user is authenticated, the Portal displays a menu of applications 66 to which the user is authorized and asks user to select one.

Once the user 70 has selected an application 66, the Server sends the authorization ticket to the selected application and displays the home page for the application. The requested application then mediates access using the authorization ticket passed to it. If the user 70 is authorized, it logs in the user and manages the user session in accordance with the application's billing model 74. For example, if the billing model is transaction based, the application will keep account of the number of transactions the user completes, whereas if the billing model is a per-use model, the application might keep an account of how long the user is “logged on” and may even ask the user to “log off’ to terminate the session.

Once a user 70 has finished working with the selected application 66, the user 70 may return to the Portal 72 to select another application 66, or go directly to another site (i.e., input a new URL). An ANX session ends when the user 70 exits the browser or connects to a non-ANX location. Note that if a user 70 wishes to go directly to an application without stopping at the Portal 72, the user may input the URL directly, and the application can then use the Authentication Service 60 to login the user 70 and generate an authorization ticket.

ANX eBusiness Integration Services

ANX Extranet Services are designed to integrate a single application process across a robust e-business infrastructure. However, there is another significant problem to solve in order to offer a complete set of e-business infrastructure services—the problem of inter-application process integration. This is precisely the problem the present e-Business Integration Services are intended to address.

The inter-application integration problem is far from new. In fact, an entire industry subcategory of software vendors has formed to address the needs of enterprises—the so-called EAI vendors, for enterprise application integration. The key word here is enterprise. All these products have been used to integrate “legacy systems” inside corporations with each other and with newer web-based applications. The present invention uses these same tools and techniques to integrate applications in the extranet space—a wholly new strategy.

Consider the situation where an e-business process involves two or more industry marketplaces. Each of these marketplaces was built using a different vendor platform—for example, the platforms offered by Commerce One, or Ariba, or Oracle. The work or transactional process will likely involve communication of:
a. Catalog information (structured content).
b. Workflow context (where in the process a communication is taking place).
c. Transactional context.
d. Process originator credentials (security information).
e. Business logic—what to do in the event of successful or unsuccessful transaction completion.

The communication and translation of this stateful, session-oriented information shows the need for an integration layer. This layer may be based on tools from companies such as Active Software, Vitria, and BEA Systems. The primary tools used to build the eBusiness Integration Services layer for ANX may include:
a. Asynchronous message queuing and brokering
b. XML-based content translation
c. Transaction management software, such as IBM's MQ Integrator™ or BEA Tuxedo™.

ANX Applications Services

ANX e-Business exists to provide e-business infrastructure services—a managed services platform that applications-level entities can use. ANX Applications Services are a set of cooperating ISVs (independent software vendors) who agree to work with ANX e-Business and offer their applications to ANX customers on favorable terms—typically via an ASP model (applications service provider). Architecturally, there is little or no impact on the ANX Managed Services Platform. However, ASPS who wish to capitalize on ANX's extranet services to achieve seamless one-time authentication, DS-based authorization, and central billing will be certified by ANX, creating a more efficient linkage to the ANX companies and communities. This is the desired outcome—applications making use of the robust e-business infrastructure offered by ANX e-Business.

Portal

There are three main additional features. One is the portal that is a robust website. The second feature is a set of collaborative applications that are launchable and accessible from the portal and share the same server information structure. The third feature is a directory service which is a separate sub-system that shares the same server complex, but it is a separate body of software, and one of the only things the directory service has in common with the portal is that the portal or the website has some of the user interface for the directory service.

The Portal is a website that may be built using the tools of C, C++, Java, and Pearl scripting. The Portal may be built using a set of software tools from Netscape, now know as I-Planet, and may run on the Solaris operating system on Sun servers. From a user's point of view the Portal is accessible through a browser, and on the ANX network that user and that browser can only access the portal through the ANX network. The Portal is not visible to the Internet. The Portal is a set of web pages that provide focused and hopefully helpful content to individuals who have gone into the group profile and accepted an invitation. Conversely, a user may leave the group by selecting this option in the group management screen. Also, a group leader may delete the user from a group. A group leader can dissolve the group or designate some other user as the group leader.

Through the Portal, the user can perform a White Page Search. A White Page Search should be able to generate and print out reports of queries. The Portal also has a feature called “My ANX features” that provides the ability to view personal invoices/bills, groups that the user belong to, and the overall status channel at the My ANX page.

Advertising may be provided on the Portal. To do so, a user places an advertisement, which includes the type of advertisement, (i.e., Banner, or Sponsorship), an e-contract, and payment terms. The Portal allows a user to confirm an advertisement purchase and upload. The Portal permits selection of an advertisement to be modified or replaced, provides for notification of the end of an advertising run, tracks views and click-throughs and by whom, and can revoke an advertisement for nonpayment or unacceptable content.

The Portal also may have a Yellow Page feature. Users can generate printed reports from the Yellow Page feature. ANX Portal Administrator or AEDA can create a new key word or category. Categories in the Yellow Pages may be modified: Category Description or, spelling, placement modification such as hierarchy.

The Portal also may have an extra-corporate LDAP based directory service deployed within a multi-provider managed network offering. A schema definition includes a definition of each and every field, its length format type, and the interrelationships of that field. The mechanisms for managing the data, accessing the data, synchronizing the data, and so on, are all completely specified in LDAP. LDAP is a publicly available specification, which is on the Internet and it is a specification that is governed by the IETF, and is a descendent of X.500.

The directory service contains information about the trading partners, their names, their addresses, their industries, some type or category information, classification information, like SIC code, and so on. The directory service also contains information about individuals. So, in the directory service, an individual, also has a name, an address, is hierarchically related to the object called “company”, and the individual has some other information contained in the directory associated with him or her. Some of the most important pieces of information are identification information and security credentials. The directory services is intended to be the repository of the certificate that governs what resources on the network, mainly applications, an individual will have access to. So in that way, there is a triad of an application, the PKI or security service and the directory service that work together to perform the function of, once the person is identified, providing them authorization, access or not, to resources.

The resources that are available can be shown in either one or two ways. Only the resources that are available to that person may be visible to that person, or all the resources may be listed and only an indication of the ones that are available for that person based on their security level will be provided, thereby giving them an indication of other services that are provided in the event that they want to subscribe to those additional services, in which case they can then upgrade their subscription to obtain access to certain other services.

A fine degree of control can be imposed through the directory service and the security service. Individuals may be provided with a view of all the resources that are available on the ANX, but then allowed access to only a subset of those resources. Conversely, individuals may have a view of only those resources that they are authorized to access.

The directory service has a user interface having several purposes. The user interface is web-based, so that its presence is known through web pages that appear to the user. The user interface includes an initial identification screen that provides a registration process to first-time users of the ANX network. Upon registration, using the combination of the directory service and application, after registration, certain new features can be made available to that same user. The user interface includes the registration and also includes the applications that are commonly referred to as white pages and yellow pages in directory technology circles. White pages are simply listings of individuals that are sortable by geography, by last name, first name, zip code, etc.

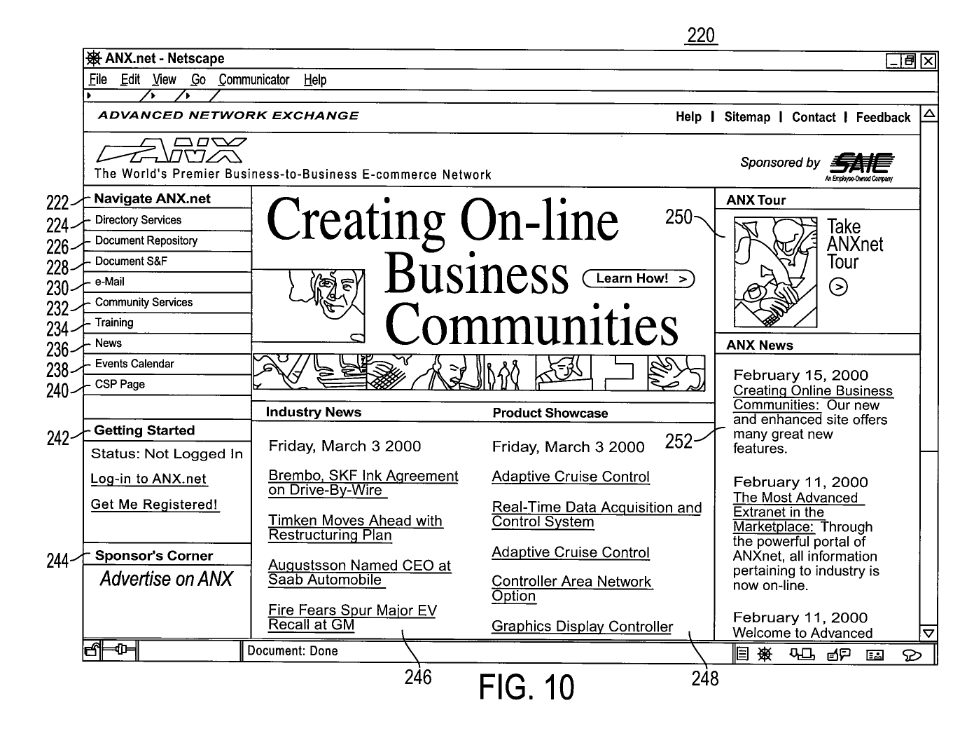

FIG. 10 is a depiction of the interface homepage screen 220 for the Portal. The screen 220 has multiple sections. A navigation bar 222 provides a guide to the various features, such as the directory services 224, document repository 226, document store and forward 228, e-mail 230, community services 232, training 234, news 236, events calendar 238, and CSP page 240. First time visitors to the ANX network can begin registration through the getting started section 242. Trading partners 52 can advertise on the homepage screen 220 in the sponsor's corner 244. Industry news may be displayed in section 246, and products may be showcased in section 248. A tour of the ANX network 50 can be initiated via section 250, and ANX news is displayed in section 252.

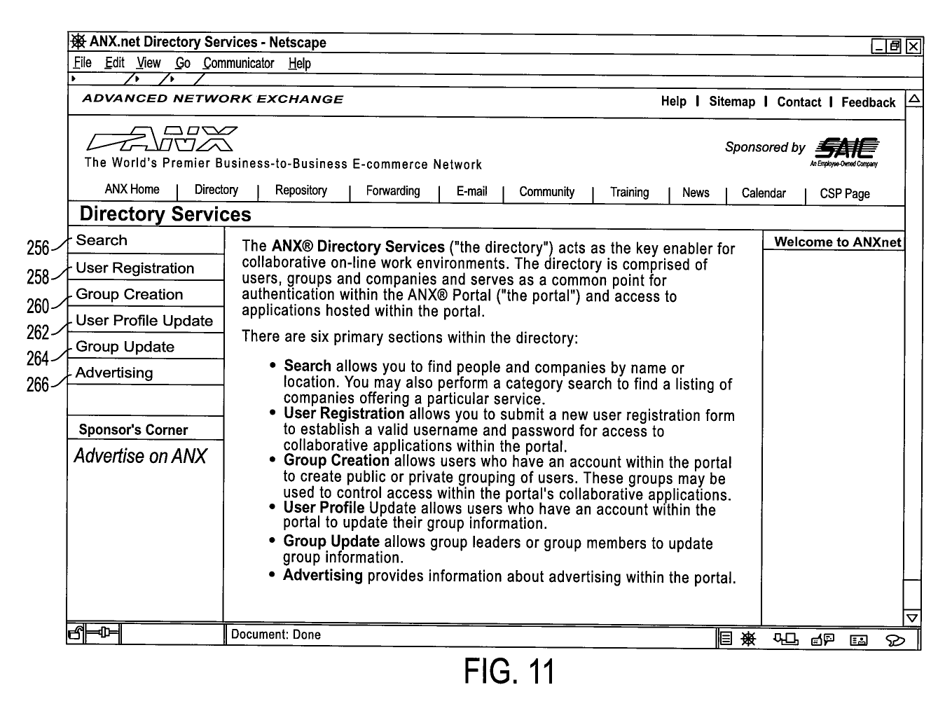

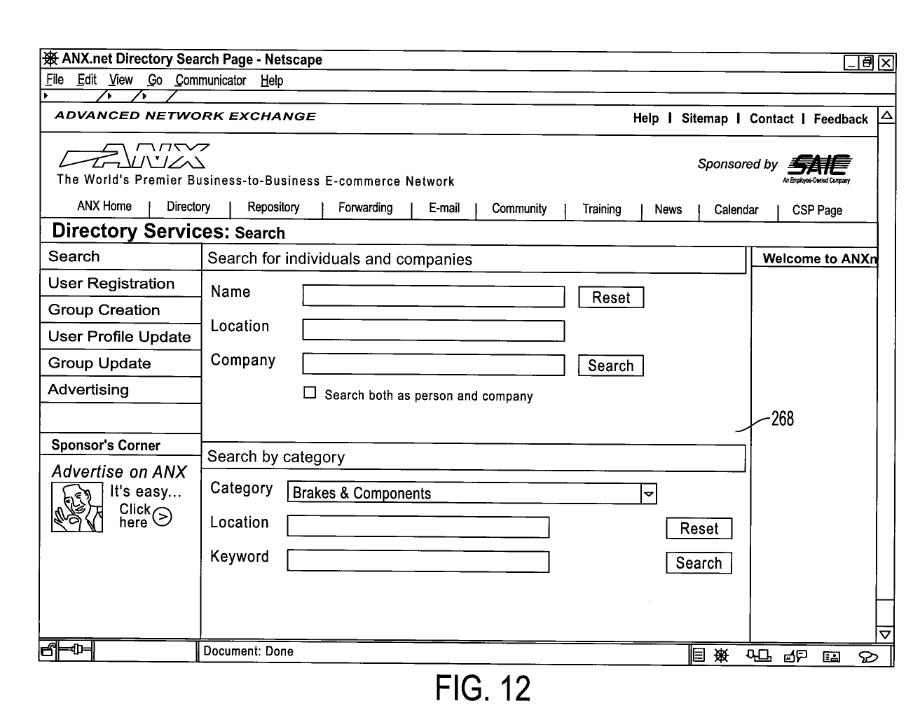

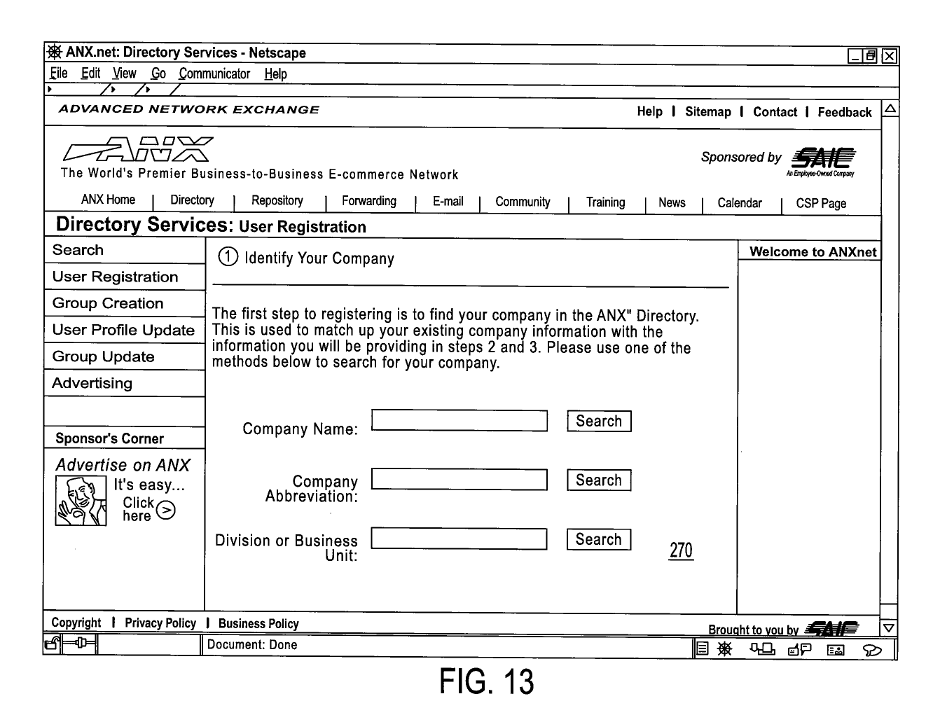

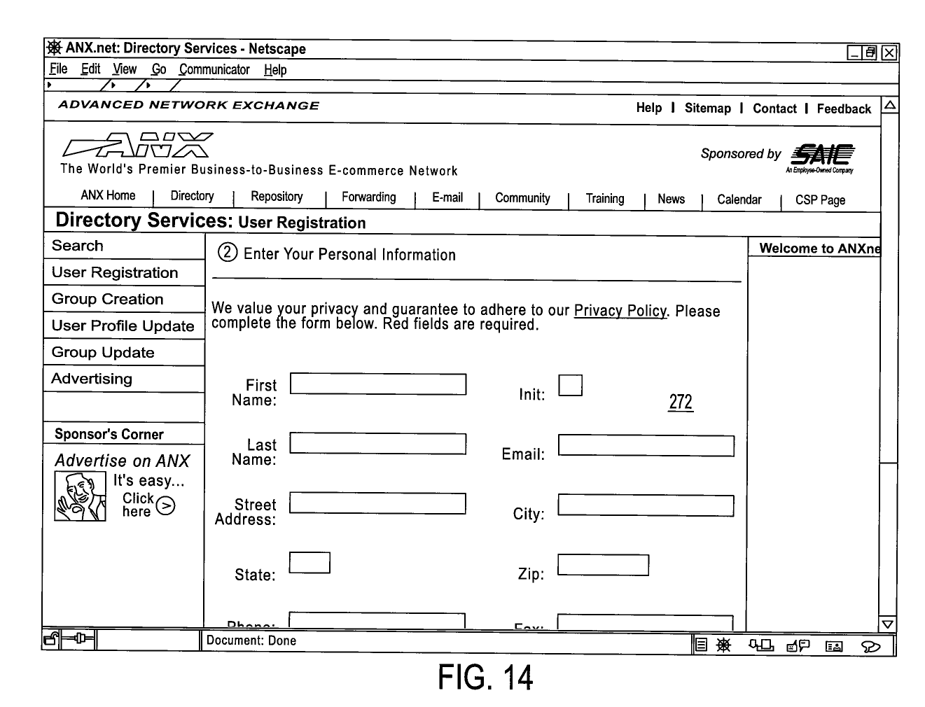

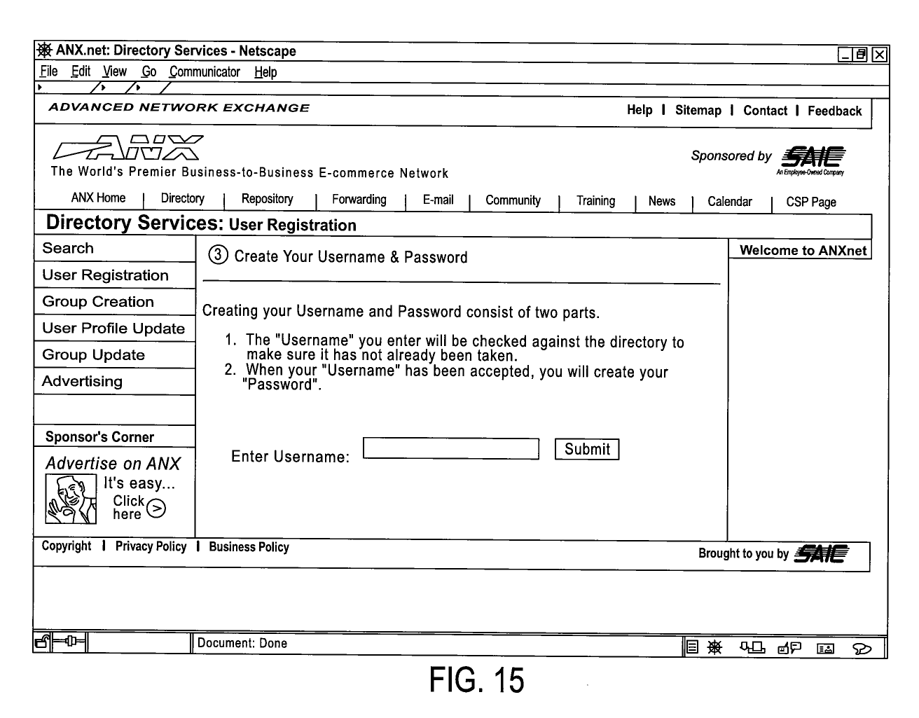

FIGS. 11-15 illustrate the directory services interface pages. FIG. 11 shows the main directory services screen 254, which is displayed when option 224 is selected from screen 220. The services include: search 256, user registration 258, group creation 260, user profile update 262, group update 264, and advertising 266. FIG. 12 is the screen displayed when search option 256 is selected. Individuals, companies and/or categories may be searched through screen 268. Various user registration screens 270, 272 and 274, shown in FIGS. 13-15, respectively, are displayed when option 258 is selected from screen 254. Screen 270, shown in FIG. 13, allows for company and division searching. Screen 272, shown in FIG. 14, is a personal information entry screen 272. Finally, FIG. 15 illustrates a Username entry screen 274.

The directory service is the data-store. It maintains the information, makes it available through very efficient access mechanisms. The white pages is an application that allows a user to view the directory service in sorted lists. The yellow pages application is aimed at viewing the corporations that are listed in the directory service, and listing them in order of geography, zip code, or some other logical subset, such as industry. The user interface is infinitely extendible. An infinite number of screens can be implemented that might be views into the directory service. In practice, an infinite number are not needed, but rather a reasonable subset. However, there is no limit on the extent of the user interface. It is just web pages and the data rendered in those web pages is always retrieved by the LDAP protocol.

The following is the directory services concept of operations. The concept of operation is a self-service or self-administered service. The basic tools for collecting all of the information about organizations and individuals who are users of the ANX network are supplied. The individual corporations will wish to control the policy of who individually registers in this directory service. Each ANX subscribing company may appoint an individual to be the directory service administrator, and that individual may implement whatever policy the company decides is appropriate. Everyone for a company may register, or one person or no one, or only persons of a certain rank may register. The company can decide to give administration authority to some third party by proxy.

Applications

While the Portal is an application, there are three closely associated applications. The applications are a document repository, a document store and forward, and email. All three of those applications will only be accessible to individuals who have registered through/into the ANX directory service, and once they have registered, then those individuals will be able to use those applications.

The portal doesn't require registration, but rather is automatically available. The three other applications are the opposite in that they require someone going through the portal to register in order to reach them. It will require someone to use the directory services user interface, which shows up as a web page to place some information into that web page.

The three applications are all aimed at being useful for collaboration in the business environment and the collaboration can be among individuals inside a single trading partner or individuals spanning any arbitrary number of trading partners, all of who are subscribers to the ANX network.

E-mail

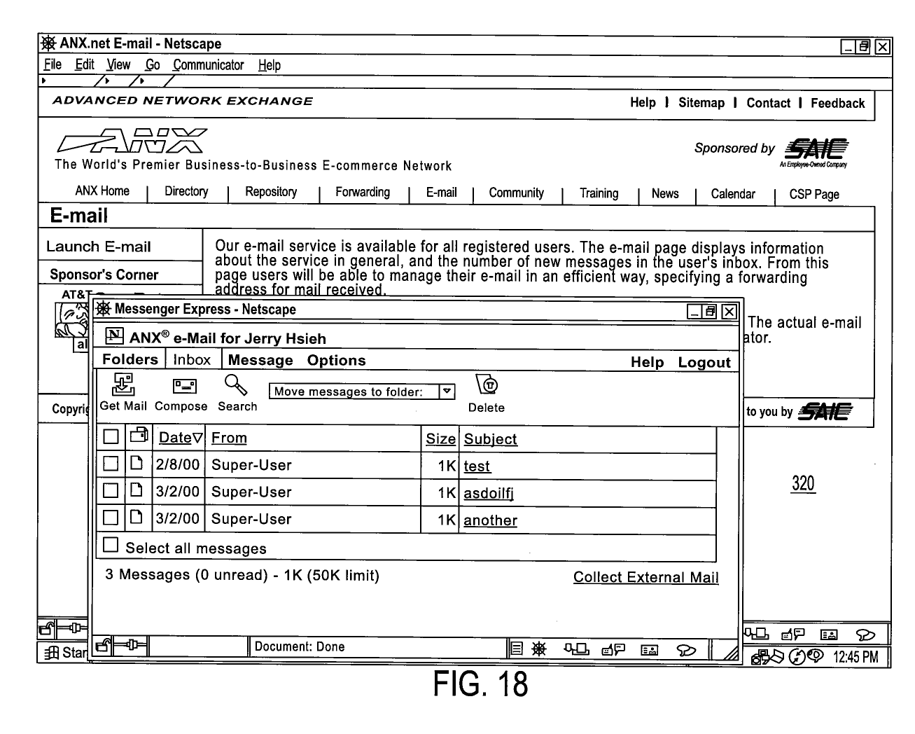

The e-mail application is based on an open source product, that is, the actual source code for the technology is freely available and published. The e-mail application provides a SMTP (simple mail transfer protocol) and POP (post office protocol) based mail service from person to person. The e-mail application has a standard set of features. He e-mail application provides the ability to send attachments, which are documents of any format that are attached to an SMTP message. In the case of the Portal, the source code may actually be HTML and script. For the e-mail service, the source code may be open source code such as C, and in the case of the other applications, the source code may be Java or C++ and Pearl Scripts. The e-mail application supports attachments, but the e-mail is limited to the ANX network. There is no e-mail crossing from the Internet to the ANX network or vice versa. The maintenance of address lists within the ANX network is supported. The e-mail interface or screen 320 is shown in FIG. 18, and is accessed by selected the e-mail option 230 from screen 220, shown in FIG. 10.

All users must have an ANX email account. All trading partners will get a set amount of free total aggregate memory (e.g. 200 MB).

The following is a first example of how the e-mail application may be used. If a company decides that no user will get a mail box on the ANX® Portal, then the emails sent to the user's email account will be forwarded a designated email account. In this way, the users associated with the specified trading partner will not exceed the free memory allocation regardless of the number of users on the Portal or the amount of emails. At the same time, because all the users have email accounts in the ANX® portal, they can utilize the ANX® directory to send e-mail to groups or users within ANX® portal. In this case, when users register, the email forwarding address becomes a requirement.

As a second example, if a company decides to give all users a set amount of memory, then as the number of users grow beyond a certain number, the free memory allocation would be exceeded and the company may be charged additional fees for the additional memory.

In a third example, the AEDA of a company may elect to provide specific users with email boxes with set memory sizes and not let other users have a mail box. The company may be charged additional fees on the basis of whether the memory limit has been exceeded or not. Companies should decide on this policy at the time of registration and the ADA will configure the directory setting accordingly. However, the AEDA may have the option of changing this setting.

One of the features of logically separating the directory function and the white pages function, from the e-mail program, is that it is much more difficult for an attack on the ANX network to use the e-mail program services, if the e-mail program gets number information or directory information through an external service which has it's own defenses.

Document Repository

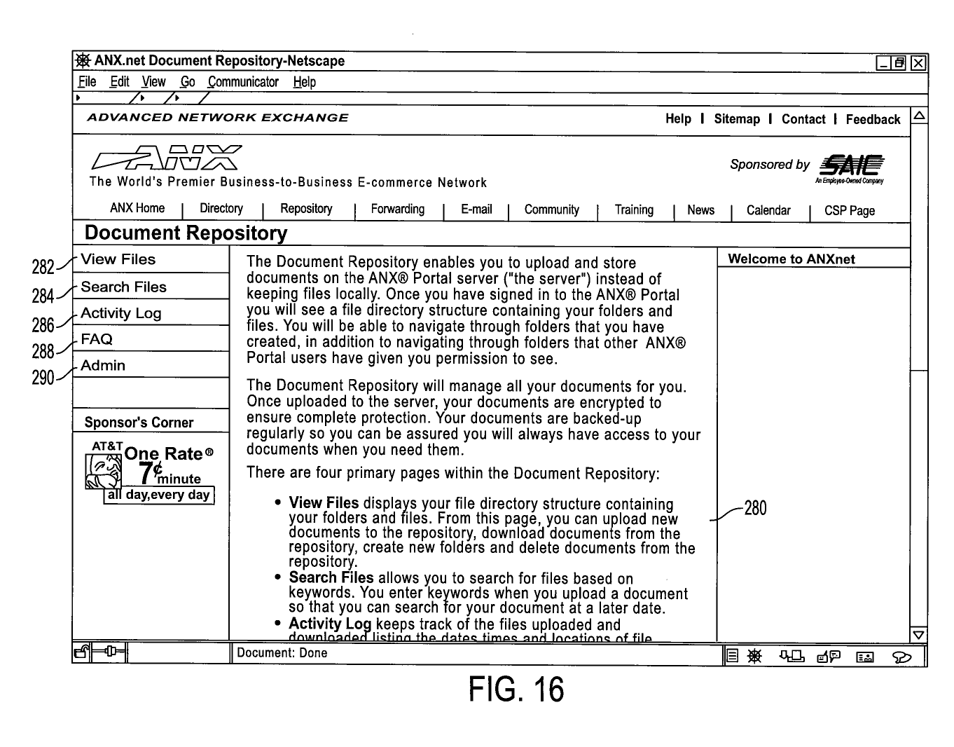

The document repository application is a new and custom Java program allowing users from multiple organizations to upload a document through the ANX network, from their own personal computer or server, to upload that document to a data store maintained on the ANX server complex and to protect that document in a secure manner. Who has read and/or write access to that document, an individual or organization or category; can be a number of dimensions. The basic functions are to upload a document and to retrieve a document or read the document. The originator of the document has the ability to specify what person or type/class of persons can do what with the document. The interface or screen 280 for the document repository is shown in FIG. 16. FIG. 16 is displayed when option 226 is selected from screen 220. The document repository screen 280 allows a user to view files in the repository (282), search files (284), review an activity log (286), review frequently asked questions (FAQ 288) or administer the repository (290).

Each individual who registers with the Portal, then has access to the document repository application and has a default limit for storage space. That default limit for storage space can be taken up by one document or multiple documents. Trading partners may be charged for their employees' use of the document repository once they have exceeded or begin to exceed a threshold.

Access is provided to the document repository by registering for the directory service, and then it is invoked through the Portal. A session that takes place is designed into the interaction of the Portal and the applications, and is invisible to the user. A context or state where the identity of the user and what they are authorized to do is tracked so that once an individual has registered with the ANX directory service—the individual may, for example, access the e-mail service and authenticate themselves with user name/password, then the individual moves over to the document repository service in the space of a single click—the individual does not have to re-identify themselves. The portal keeps track of the identity of the individual and what he or she is authorized to do. One of the most irritating things to users, and in particular business users who are always pressed for time, is the constant request to re-identify themselves as they cross application boundaries that are generally invisible to them. In the ANX network, once a person has authenticated themselves with any of the applications, the other applications that are integrated with the directory service and the Portal will recognize the person and will not ask for re-identification. So that much of the state information is held.

The next feature is document store and forward, and is a custom program, that may be written in Java. The store and forward application provides the ability to upload a document to a temporary repository, and to specify destinations for a document to any addressee who is known to the directory service inside the ANX network. One of the things that a user of the ANX network gains through the registration process is a unique mailbox address, which is the address that is referred to in the store and forward application. A document is stored in a temporary repository and it is forwarded to a destination address. The existence of the document is made known through messages to selected individuals. The recipient receives an e-mail message informing him or her of the document's existence, it's location, how to retrieve the document, and how long the document will be at the location. The sender can specify the recipients, what the recipient's permissions for use are, and how long the document is to remain in the store-and-forward state.

It is a closed universe inside the ANX network, so an individual will only get documents from other individuals who are part of a subscribing company. There is a fairly large set of in-use permissions that can be tagged onto the object or document. The permission set is large. For example, there is read permission, there is download permission, there is modify permission, there is forward permission, etc. If you are not the originator, you cannot forward the document to someone else. The recipient has to go back to the originator to get permission to do anything with it. The program can be implemented to allow almost any permission but it is restricted to a certain set. Confirmation of receipt is another feature.

Accountability includes the sender knowing that the recipient, knowing that the recipient, knowing that the recipient has accessed the document, has read the notification message, has received the notification message. These are all tracking and accountability features that are built into the store and forward application.

A sender can make the same document object available to multiple recipients and each recipient on that broadcast list can have a different set of permissions associated with the document. For example, for a project team where a document originator wants everyone else on the project team to see the document, perhaps only the team leader will be allowed to alter the document.

If a person is a member of the ANX network and registered with the directory service, he or she will have access to the foregoing three applications.

The Portal, directory service, and the applications are all accessible by any individual inside any subscribing company, and the applications are subject to those individuals having to register with the directory service. The applications may have a limited use policy that says that they are useable up to some limit. For e-mail the limit may be the number of messages and/or size of the message stored. For the document repository and document store-and-forward, the limit may be the total storage size.

One of the features of the Portal is an automated process for retrieving information from a public Internet site called Vertical net. The automated process moves copyrighted information published on the Vertical net site to the Portal and makes it available to ANX subscribers. The process includes a transient connection of the ANX portal to the Internet resident Vertical net portal. A port is opened at random times and the connection is transient so that the opportunity for someone to take advantage is diminishingly small. File transfers are used and are rendered on the ANX Portal. All individuals having access to the ANX portal may see the same information.

One of the features of the Portal is to provide the substrate for advertising. The Portal can be a delivery mechanism for advertising. This is a well-known thing in the Internet space and the ANX network Portal may use exactly the same tools and techniques for, not only rendering the advertising, but also monitoring its viewers. In terms of application service providers (ASPs), the Portal may also be the launch point for users to gain access to ANX partner applications. Applications that are resident on the ANX network may be owned and operated by the trading partners. An ASP is a company that may have a web-base business model and that can sell some sort of useful information or collaboration service through the network on what is probably a subscription basis. The principal way of getting to the ASP application will be through an advertisement on the ANX network, that allows access to collaboration services by clicking on the advertisement and the user context moves to the e-room site, which is also part of the ANX network. The Portal becomes simply a launch point for those revenue generating application service providers (ASPs). The service providers will not be responsible for substantiating that a user has subscribed to the ANX.

On the ANX network, someone representing the corporation, not someone representing himself or herself as an individual, may purchase an application service. There may be a very strong administration of who is allowed to sign up as an ANX network resident ASP, due to the fact that typically a corporate commitment is being made. The directory service can contain the information about who the corporate administrating individual is, and can contain, if the corporation chooses to do this, the authorization certificates or information for what applications that individual is authorized to use, and those can be internal applications, external applications, or ASPS. The corporate administrating individual for each corporation permits access to the ANX network through their corporations. Any employee of a subscribing company has the ability to look at the portals contents through their corporate intranet.

The Portal is the “Home Page” for the overall ANX network. The Portal provides ANX subscribers with services and tools for collaborating in on-line communities. These services include directories of trading partners, companies and individuals; industry news and events; email and calendar services; secure document repositories and store-and-forward services; and discussion groups. The ANX Portal draws heavily on Alliance Partners. In particular the Portal may make significant usage of Sun/Netscape software products and development collaboration; and content provided by Vertical Net.

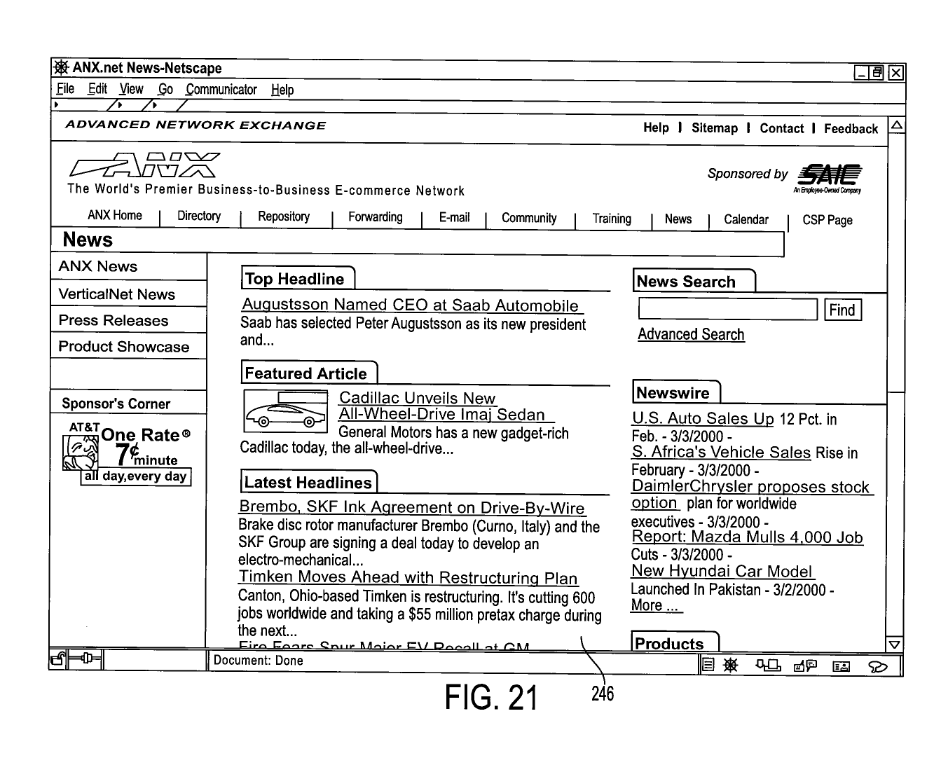

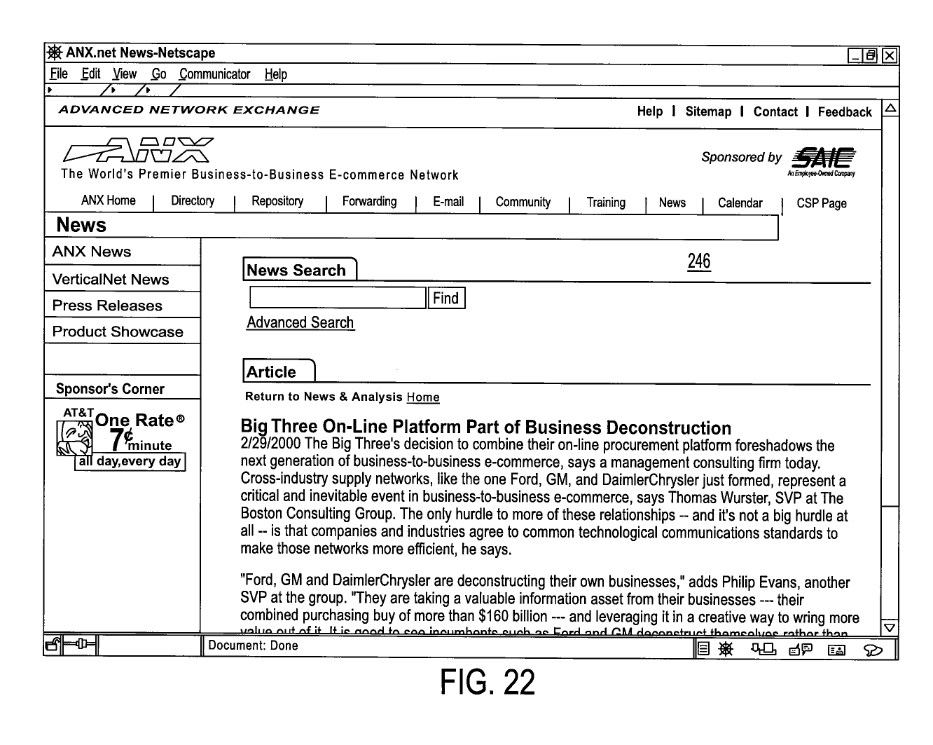

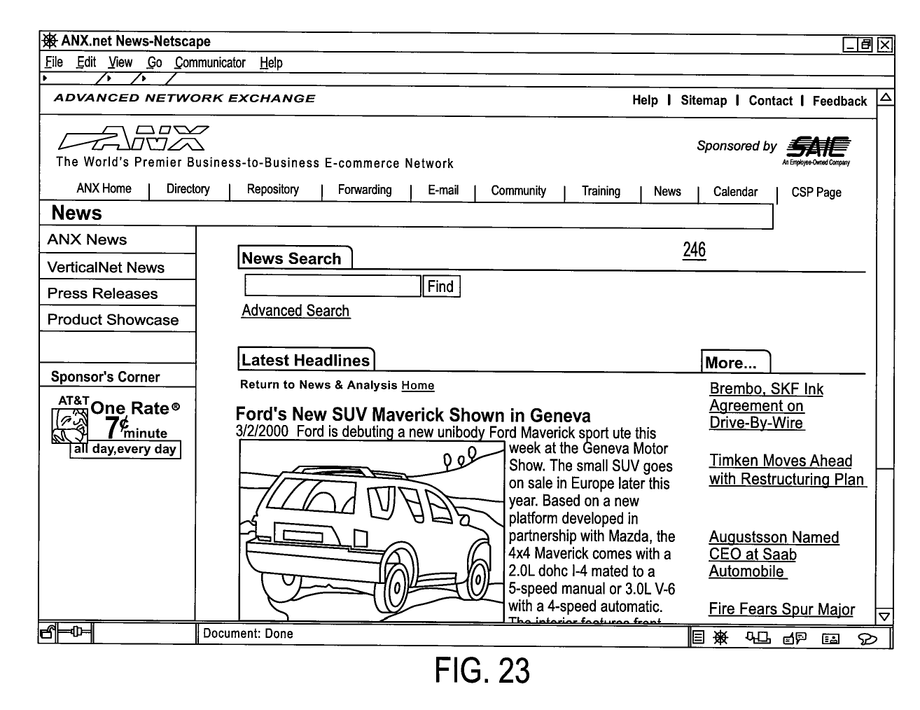

The directories can include a list of trading partners, companies and individuals; a search capability by multiple attributes; and companies may place ads in company listings. The industry news and events portion contains industry news content that may originate with Vertical Net. Alternatively, the information may come from autoCentral.com with co-branding between ANX and Vertical Net. The industry news interface or screen 246 is shown in FIGS. 21-23. FIGS. 21-23 show variations in the manner in which the industry news is displayed.

The e-mail services include e-mail accounts for ANX subscribers; and the ability to forward ANX e-mail accounts to already established preferred e-mail accounts. A subscription fees may include a certain amount of storage space. The user may pay for a greater amount of space based upon usage.

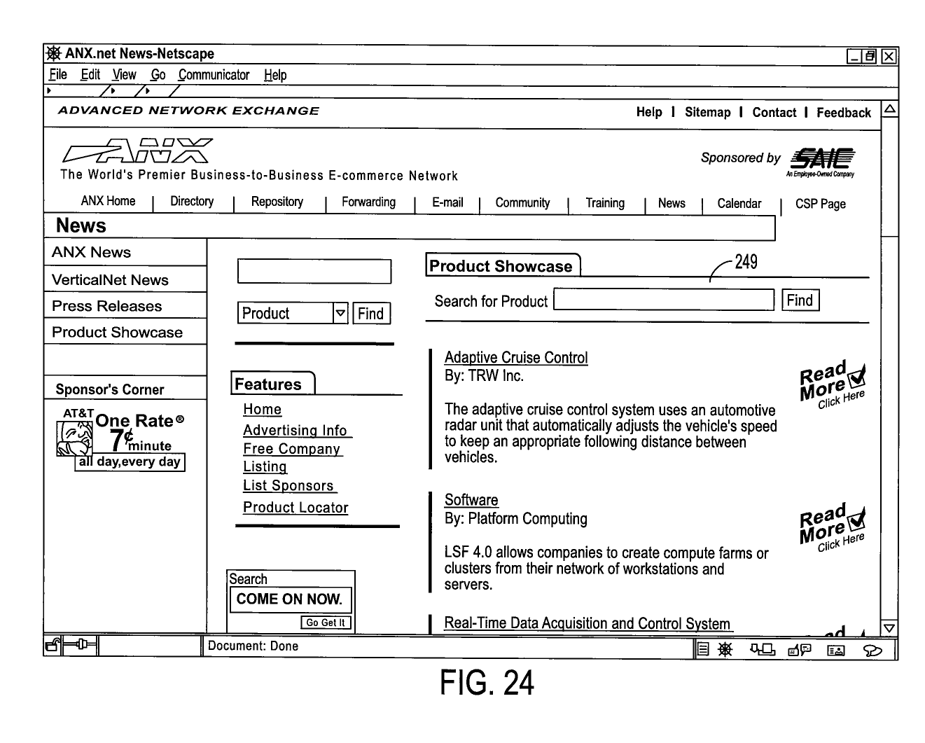

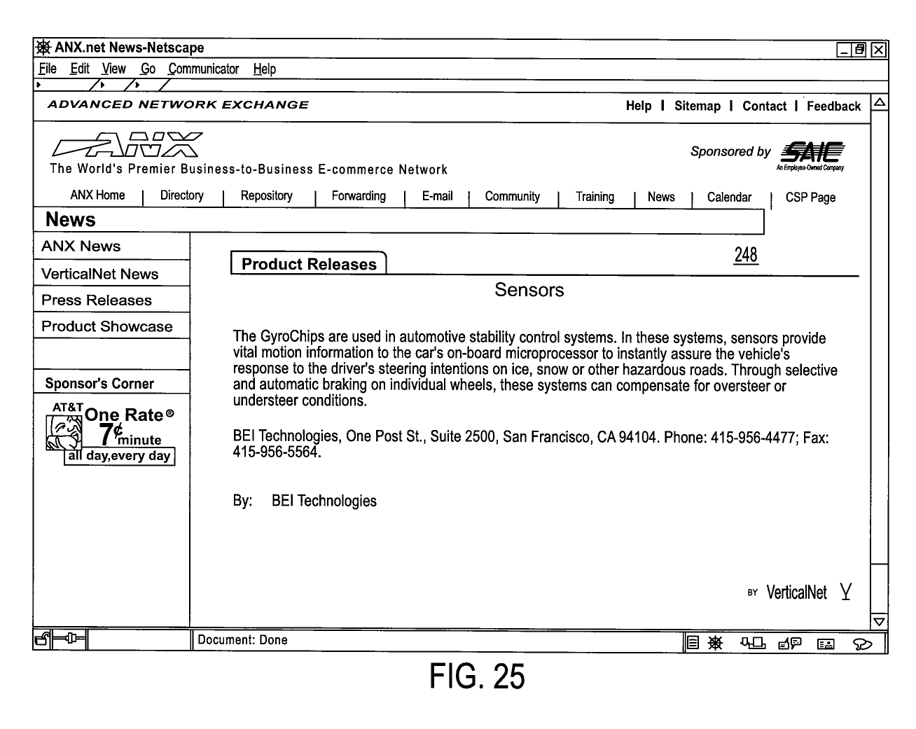

A product services interface or screen 248 may be provided for subscribers to showcase their products, and is shown in FIGS. 24 and 25. FIG. 24 provides a product search screen 249, and FIG. 25 is an example of a product release article screen 248.

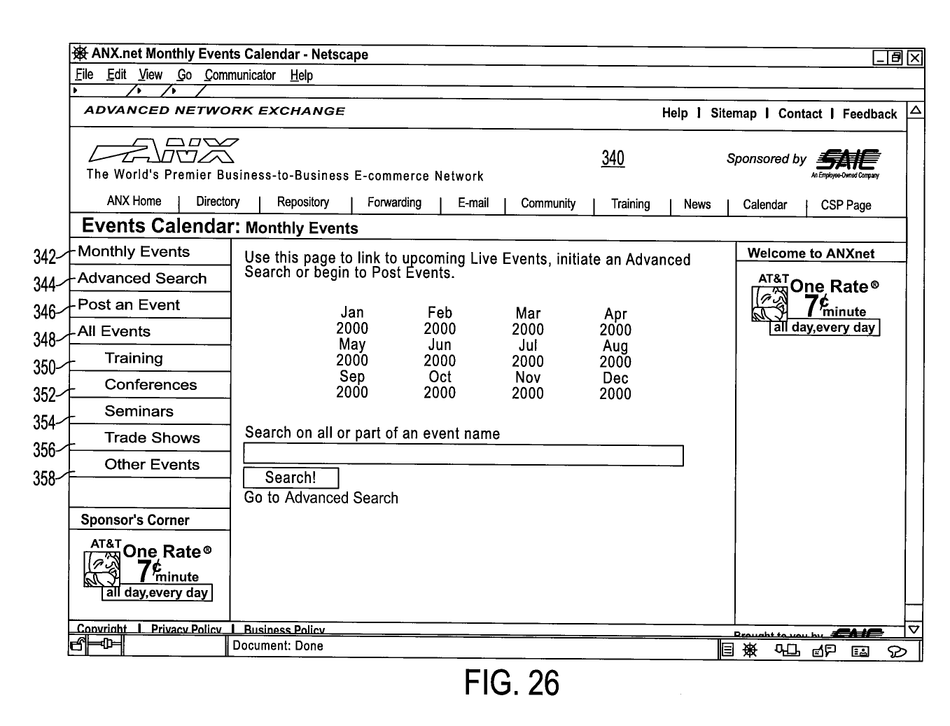

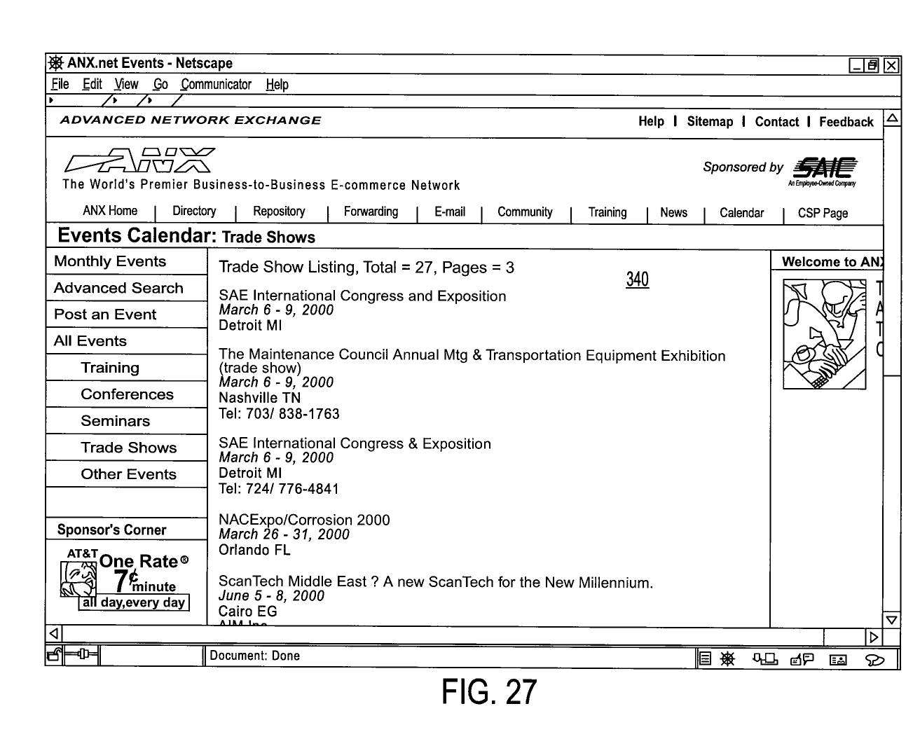

The calendar services may show industry events and can include plans for host group and individual-level calendars. A calendar interface or screen 340 is illustrated in FIGS. 26 and 27. In FIG. 26 the screen 340 has options for monthly events 342, advanced search 344, posting an event 346, all events 348, training 350, conferences 352, seminars 354, trade shows 356, and other events 358. Searches may also be performed for events by date or event name. FIG. 27 is an example of a screen 340 showing the results of a search.

The document repository is a secure document storage capability on the ANX network. The originator can specify document protection. Pre-defined storage is provided as part of the ANX network subscription fee.

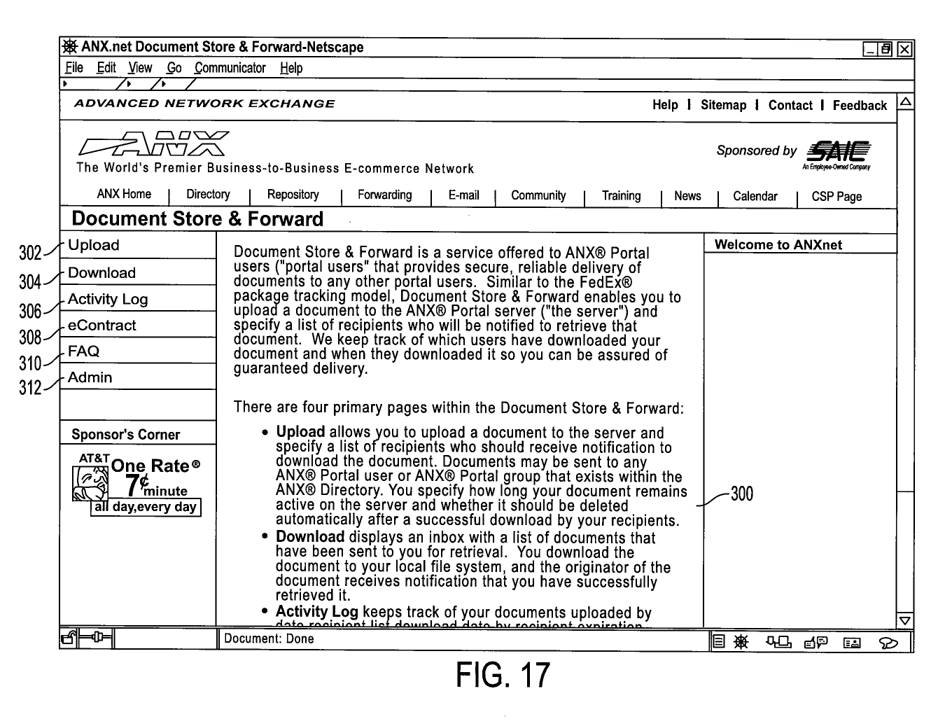

The document forwarding allows ANX subscribers to send documents, such as large CAD files to other ANX subscribers via the ANX network. Recipients receive notification when a document is in their “inbox.” An activity log tracks upload/download activities. The interface or screen 300 for document forwarding is shown in FIG. 17. The available options through screen 300 include upload 302, download 304, activity log 306, eContract 308, FAQ 310, and Administration 312.

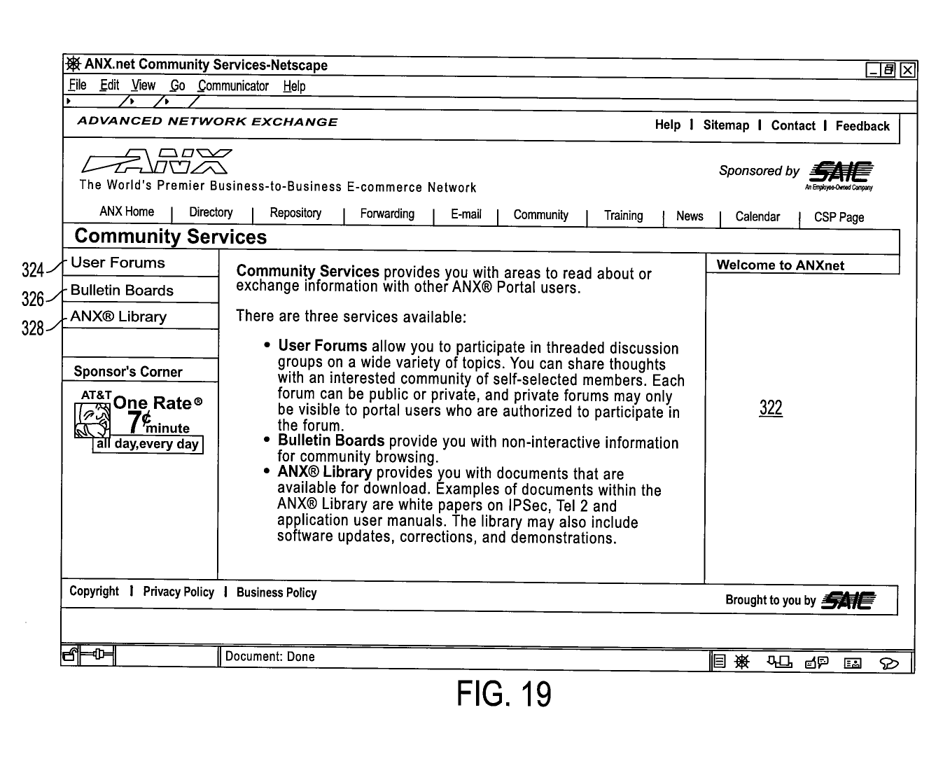

A community services interface or screen 322 is shown in FIG. 19 and provides subscribers with areas to read about and/or exchange information with other ANX network Portal users. The community services screen 322 may have options, such as user forums option 324, bulletin boards, 326, and an ANX library 328. The community services screen is selected by choosing option 232 from screen 220.

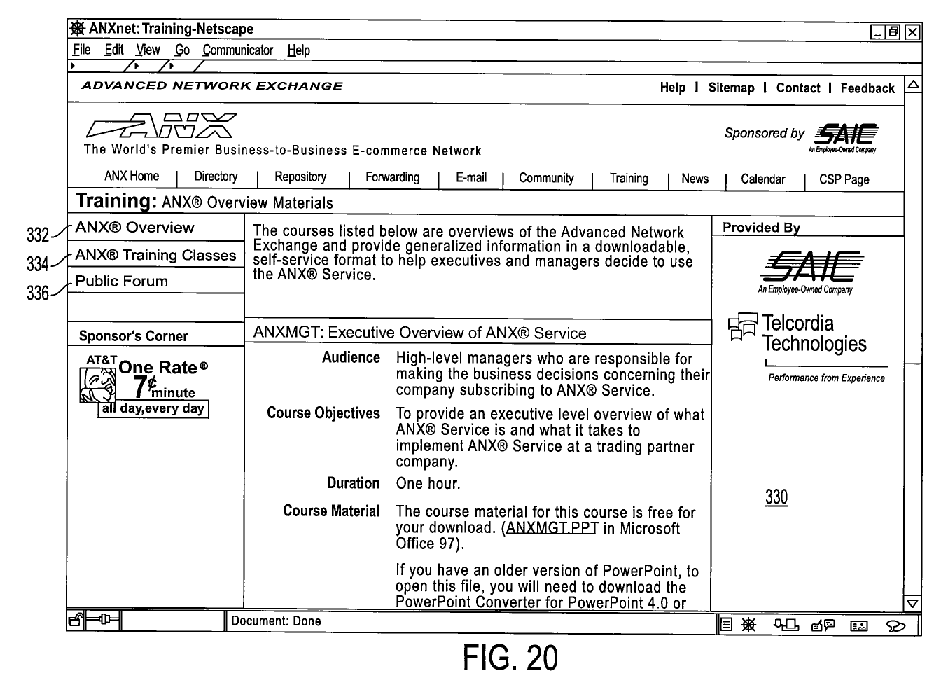

A training interface or screen 330 is shown in FIG. 20, and is selected from the training option 234 in screen 220. The training screen allows a user to select an ANX overview 332, ANX training classes 334, and a public forum 336.

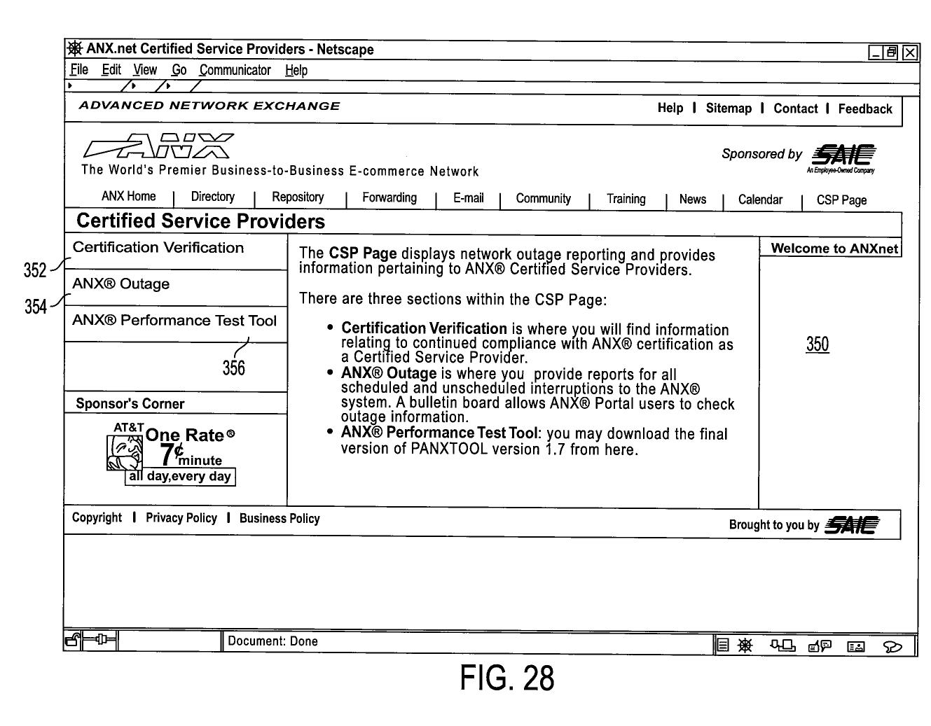

The discussion groups allow for public or private discussion forums. Tools are provided to allow the subscribers to scan and search discussion groups that they have permission to access. The discussion groups provide a central location for secure, company specific discussions, and provide a central place for commonly requested information, such as certified service providers, ANX questions, etc. For example, FIG. 28 shows a CSP interface or screen 350. Information relating to continued compliance with ANX network certification can be found for a CSP 54 through the certification verification option 352. Reports of interruptions in service are found through the ANX outage option 354. An ANX performance test tool can be downloaded through option 356.

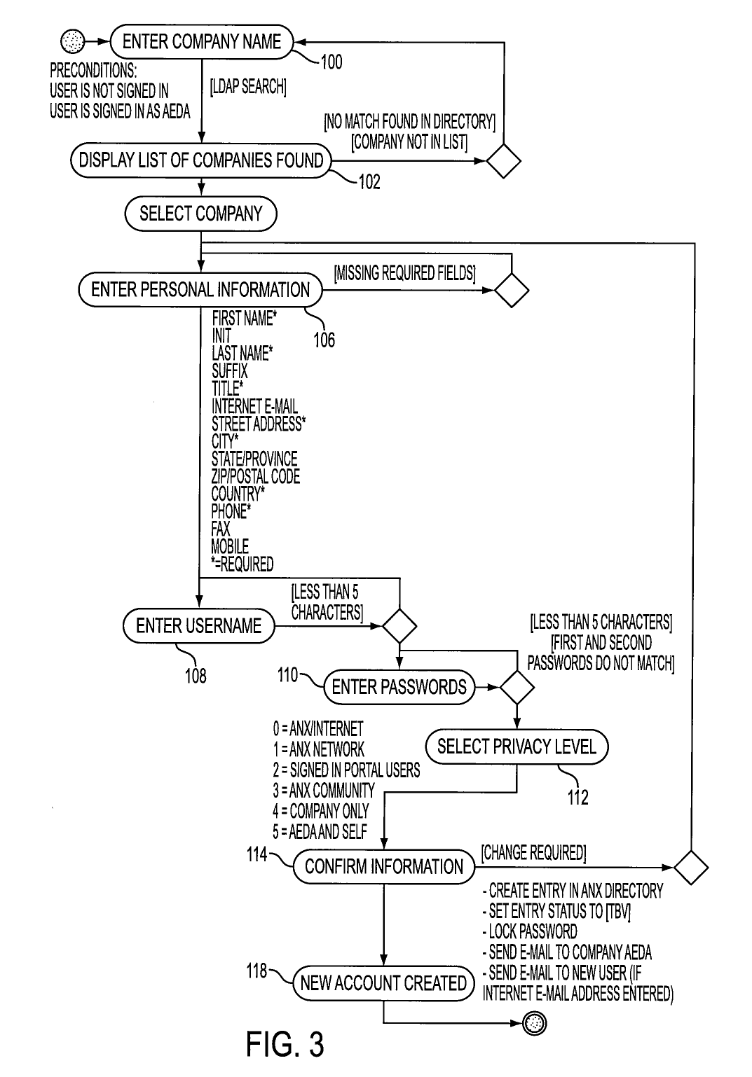

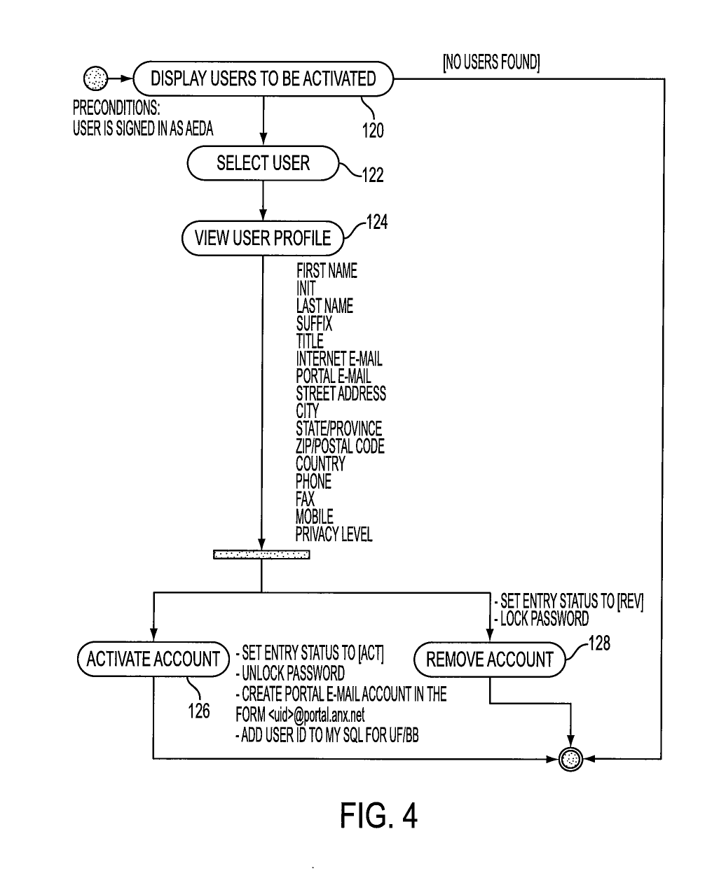

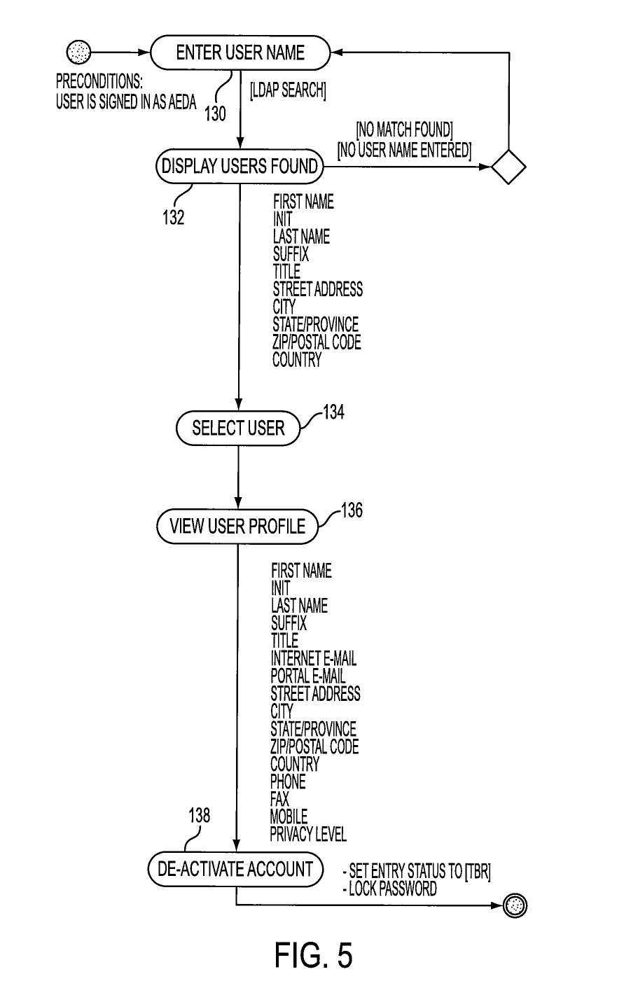

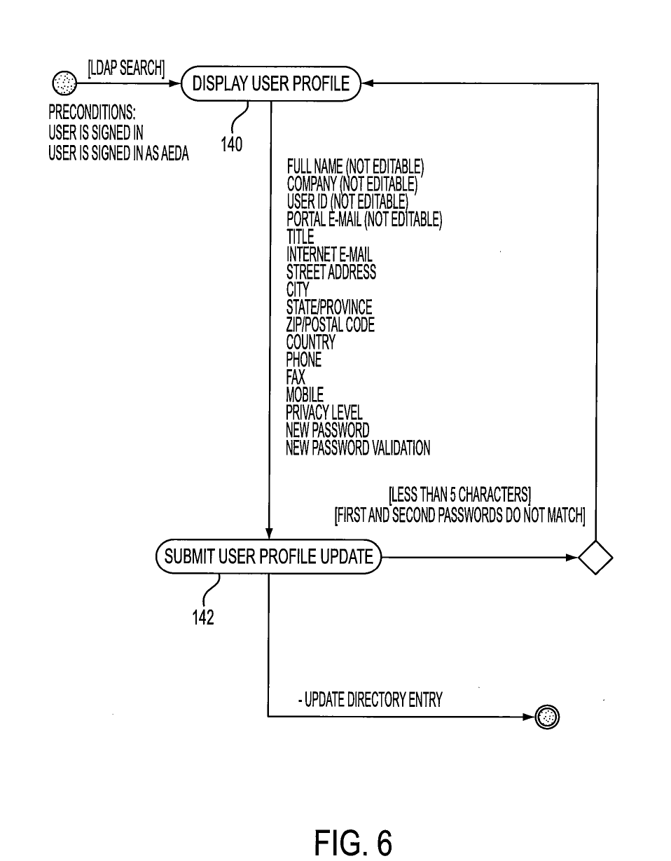

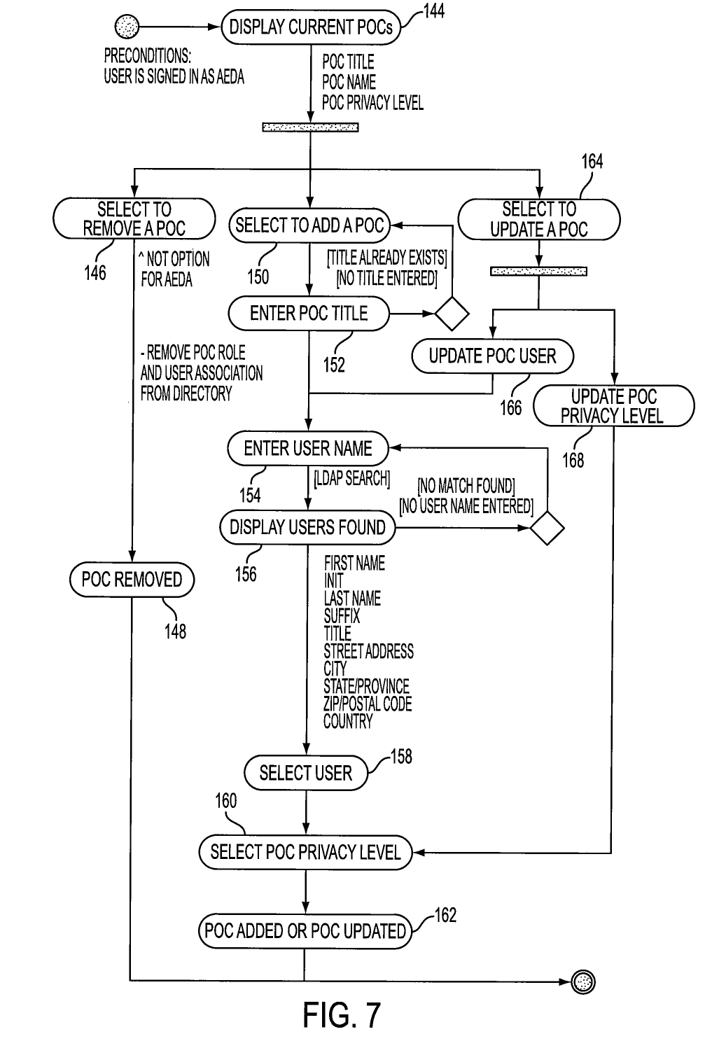

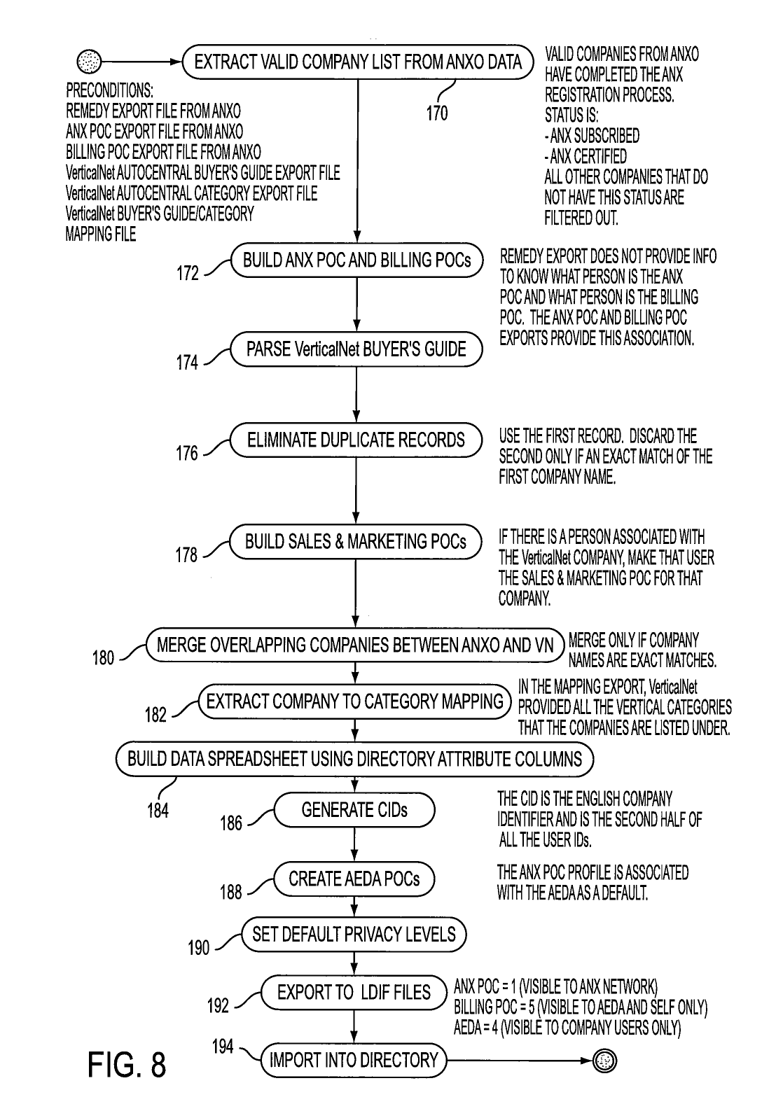

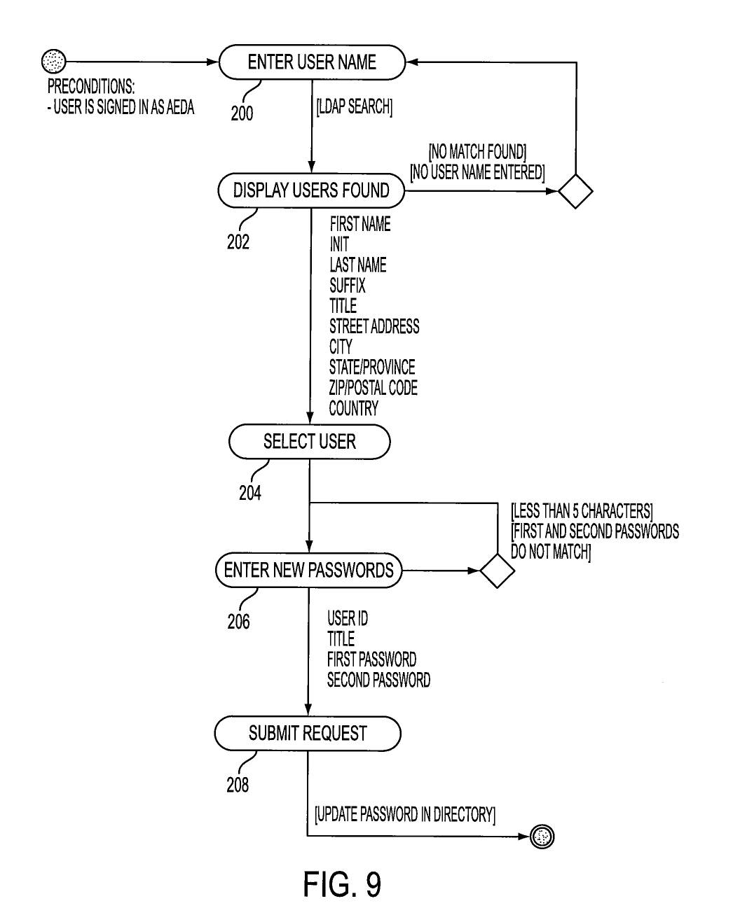

FIGS. 3-9 are flow charts showing portal processes. In particular, FIG. 3 shows the process for creating a new account. FIG. 4 shows the process for activating a new account. FIG. 5 shows the process for deactivating an account. FIG. 6 shows the process for updating a user profile. FIG. 7 shows the process for managing company points of contact. FIG. 8 shows the process for importing directory services. FIG. 9 shows the process for resetting passwords.

Referring to FIG. 3 the process for creating a new account will now be described. A name of a company (trading partner) is entered in step 100. A list of companies found are displayed in step 102. If the name entered in step 100 does not match a name on the list displayed in step 102, step 100 is repeated. If the name entered in step 100 matches a company name found in step 102, the AEDA may select that company in step 104. The personal information for the individual pertaining to the new account is entered in step 106. All the fields of information must be entered in step 106 before proceeding to step 108 where the users name, less than five characters, is entered. A password, less than five characters, for the account is entered in step 110. A privacy level is selected in step 112. The privacy levels are 0=ANX/Internet, 1=ANX network, 2=Signed in Portal users, 3=ANX community, 4=Company only, and 5=AEDA and Self. The information is confirmed in step 114 and the new account is created in step 116.

The activation of a new account is performed in accordance with the flow chart shown in FIG. 4. Users to be activated are displayed in step 120. A user is selected in step 122 and the selected user's profile is displayed in step 124. If the profile is acceptable the account is activated in step 126. On the other hand, if the profile is unacceptable, the account is removed in step 128.

An account can be de-activated in accordance with the process set forth in the flow chart shown in FIG. 5. A users name is entered in step 130. Users found that match the entered name are displayed in step 132, and the desired name is selected in step 134. The selected user's profile is viewed in step 136 and the account is de-activated in step 138.

To update a user's profile the process set forth in the flow chart shown in FIG. 6 is followed, where a user's profile is displayed in step 140 and the profile is updated in step 142. The users name and passwords must match to complete the update.

Referring to FIG. 7, the process for managing a company's points of contact POCs is outlined in the flow chart. Current POCs are displayed in step 144, including each POC's title, name and privacy level. In step 146 a POC can be selected for removal, which accomplished in step 148. A POC can be added in step 150. The POC's title is entered in step 152. If the title does not already exist in the system the user's name is entered in step 154, otherwise step 150 is repeated. Users found, corresponding to the entered name, are displayed in step 156. The desired user is selected in step 158 and the POC privacy level is selected in step 160. The POC is then added in step 162. A POC may also be updated by selecting to update a POC in step 164. If the POC user is to be updated, then step 166 is followed which leads to steps 154-162. On the other hand, the privacy level of a POC may be updated in step 168, which is then followed by steps 160 and 162.

Directory Service

The directory service is a product that may be based on the Netscape LDAP server. LDAP stands for the Lightway Directory access protocol, which is no longer just an access protocol, it is actually a specification for how one does a complete directory service. A directory service is a very efficient structure data-store. The directory data store is accessible by the protocol called LF, which runs on top of TCP. The ANX directory service can contain information about corporations, name, place and type information.

The directory service can do nothing without a schema. A schema describes the fields that the data store holds and their interrelationships. It looks like a tree structure.

Referring to FIG. 8, a flow chart illustrating the process for importing directory services is set forth. In step 170 a valid company list is extracted from the ANXO data. ANX POC and Billing POCs are built in step 172. A Vertical Net Buyer's Guide is parsed in step 174, and duplicate records are eliminated in step 176. Sales and marketing POCs are built in step 178. Overlapping companies between ANXO and VN are merged in step 180. Company to category mapping is extracted in step 182. A data spreadsheet using directory attribute columns is built in step 184. CIDs, the English company identifiers are generated in step 186. AEDA POCs are created in step 188, and default privacy levels are set in step 190. The data is then exported to LDIF files in step 192 and the is imported into the directory in step 194.

The flow chart shown in FIG. 9 sets forth the process for resetting passwords. A user's name is entered in step 200. Matching users are displayed in step 202 and the desired user is selected in step 204. A new password is entered in step 206. If the first and second passwords match the request for a new password is submitted in sep 208, otherwise step 206 is repeated.

Registration Process—New Trading Partner Company Registration

When a new company applies to become a trading partner on the ANX network, as part of the application, the company must designate a AEDA and if the company desires, the company may also designate AEDDAs and provide on paper the following information:
1. Company Profile (e.g. a paragraph describing what the company does—may be used in the yellow page).
2. Company Product/Service portfolio of offerings—may be in the yellow page.
3. Key Words—may be in the yellow page.
4. Date and version of the physical contract for ANX connectivity.
5. Dun & Bradstreet Number.
6. Points of Contact (These POCs may be the same person if the company chooses which may be the case in small companies).
a. Sales & Marketing—may be required and may appear to the ANX community and in the Public Internet.
b. ANX—required and will appear to the ANX community and in the Public Internet.
c. Financial—may be required but may choose to or not to appear to the ANX community and in the Public Internet.
d. ANX Enabled Applications (e.g. CAD, ED])—Optional.
e. AEDA—required and will appear to the ANX community only.

The company registration is handled offline and the initial data is entered into the ANX directory by the ADA

The initial set-up entry is to be reviewed and verified by the AEDA via ANXO.com with a temporarily assigned password, which is emailed to the AEDA. The AEDA's user ID will be AEDA trading partner name. When the AEDA logs on for the first time, the system should prompt for a new password chosen by AEDA. Additionally all the POCs and AEDA will also receive personal accounts with the user IDs and temporary passwords via email. As in the case of the AEDA, when any user logs on for the first time, the user is prompted to change the password and also enter a back-up question to remember the password. The person designated as the AEDA must log in as a user separately to gain access to other functions of the ANX Portal since the AEDA account should only be used for directory management activities.

A company has the option to breakdown by division in which case the company must designate AEDDAs for all the divisions and optionally, POCs at the division level for sales and marketing, ANX, financial or others. Additionally, the company has the option of having separate corporate profiles by division.

The trading partner name will be the Domain name for the company. If the company does not have a domain name, the company may select a name that does not duplicate any existing domain names. In case of divisions, if the division has a unique registered domain name, then that name will be used. Otherwise, the company may designate a unique division name. In all cases, there will be no spaces within the names (userid.division_name.TP_name). Also during the paper registration process the company decides what certain policies, which will be discussed later. Once a trading partner is set-up, the AEDA or AEDDA can now begin the authentication process for the users.

Existing Trading Partners on the ANX Network

The ANX contacts from the companies must be contacted by the ANX Overseer and the new requirement must be explained. All the ANX contacts will be temporarily designated as the AEDA. The billing contact will be automatically designated as the POC for financial issues. The temporary AEDA is encouraged to enter in data and designate POCs. As above, the person must be a registered user and must appear in the ANX directory before that person can be designated as a POC. The only exception will be in case of AEDA. The existing trading partners must provide the same information as the new trading partners.

An ADA can reset passwords for the AEDA. An AEDA can reset passwords for the AEDDA and designate users associated the same company to be a POC for the different functions. An AEDA can reset for passwords for users within the same company. An AEDDA can reset the passwords for users within the same division and designate users associated the same division to be a POC for the different functions.

The user registration process will now be explained. A user registers in one of two ways. Sign up directly on-line through the ANX® portal or via the AEDA who pre-configures the user. The latter is more likely to happen during the initial set-up phase. If the token system is in place, the user can contact the AEDA and request a token. When the user registers, the user will enter in the token number along with the required information and the registration is instantly approved. If the token system is not in place, then the user registration is forwarded to the AEDA for internal authentication and validation. When the user is authenticated and the registration accepted, the user ID and a temporary password are sent to the notification e-mail address. Once the user logs on for the first time to the ANX Portal, the user is prompted to change the password. The user ID will have the form of last name first initial(.Division name) trading partner name.

Required information from the user includes: name, title, telephone number, e-mail address—forwarding if applicable, e-mail address—Internet e-mail address for notification on ANX service, facsimile number, company, division, visibility—does the user want their name and contact info to appear to the ANX Public?—Do the user want their name and contact info to appear to their TP community? A token or employee number, and optional information including: industry of interest, functional specialty, and areas of interest. Furthermore, the ADEA may define other fields.

All customer service inquiries from companies should be routed to ANX Overseer initially. An e-mail address should be set-up for customer service for Portal issues.

While many screens may be optional, certain screens are necessary. The necessary screens include: an ADA screen for initial set-up and populating of the company information; an ADA screen for resetting the AEDA's password; an AEDA Screen for resetting the AEDDA's or user's password; an AEDA screen for defining POCs and designating a registered user to be the POC. A screen for entering company profile data to be accessible by the S/M POC, and an AEDA screen for reading and accepting user request for registration.

Public Vs. Private

Companies should, as a default setting, allow users to be seen by the ANX public or not. Some companies may not want any of their registered users to be seen by the ANX community with the exception of the POCs. In other companies, they may permit the users to decide. Thus depending on the policy set by the company, the user's choice in visibility may be overridden. Taking this idea one step further, certain personal fields may be hidden from the ANX public such as the position or title, telephone number, etc., by personal choice or company's choice.

Billing

Nominally, the finance POC should have the sole access in viewing bills or monthly invoices generated by Portal usage consolidated and also broken out by user or application as well as being able to look at archival information. An electronic payment mechanism may be employed.

The sales and marketing POC may have the sole access to change the company profile data in the ANX Portal. In smaller companies, the AEDA and sales and marketing POC may be the same person. The user designated as a POC should be able to login and access the POC window with its ability to view POC specific content and e-mails as well as the ability to change the data.

Users should be able to update their profile after logging in. If the user has moved to a different division then the user can change the user's home division, which should trigger a notification to the new AEDDA. The new AEDDA can accept the change before the user regains the full rights (i.e. the user can accept e-mails and documents but cannot forward or send).

Companies and users can be deregistered. When a company actively disconnects the ANX service by sending a written notice to the Overseer, then the entire company profile and user profiles will be deleted from the ANX directory. If any of the users of that company belonged to a work group, then a notice will be sent to he group leader as well as removing the users from any group lists. User deregistration should be performed by editing the user profile.

There are three instances of removing user information from the ANX directory:
Case #1: A user may wish to be deleted from the ANX directory.
Case #2: A user may have left the company and the AEDA removes the user from the directory.
Case #3: A user has not responded to request for user profile update and after being put in inactive status, is removed automatically.

In case # 1, e-mail notification is automatically generated to the AEDA and the ANX Portal administrator. The user is taken to a special screen where the user designates the reason for deletion:
Leaving the company,
Change in responsibility which no longer requires ANX connection, or
Dissatisfied with the performance.

A forwarding e-mail address is requested to forward mail for a two-month period. After that the e-mail account ceases to exist. The user's profile is put in an inactive status for two months and will not be viewable in any directory and even manual add-on to a group may not be allowed. The user is automatically deleted from all groups and an automatic e-mail is sent to all group leaders to notify them of the change in status. An e-mail may be sent to the user by the ANX Portal administration to do a customer satisfaction survey.

In case # 2, the AEDA is taking the action. An e-mail is generated to the ANX Portal administrator. Forwarding e-mail may be requested but is not required in this case. E-mail is automatically generated to all the group leaders and the user is removed from all the groups. The user's profile is put in inactive status for two months then deleted completely by the system.

In case # 3, the user has not responded to repeated requests for user profile update and is deemed to be not active. The user is put in inactive status for two months and removed after two months. E-mails are automatically generated to the AEDA and ANX Portal administrator and to all the group leaders.

An inactive user may be reactivated by getting in touch with the AEDA. Thus, when a deactivated user tries to log on, the correct prompt should appear advising the user to get in touch with the appropriate POC or AEDA.

Users should be able to create groups, name the group, and decide whether to make it a public group or a private group. A public group is visible in the ANX directory with a brief profile on the group. The group leader will be e-mailed when a user outside the group sends e-mail to the group. The members of public groups may or may not be listed depending on the choice of the group leader. Private groups can be private only to within the trading partner or may be completely private that only the members will see the group in the directory.

A group leader will select the members of the group. The selected group members will be invited to join by an e-mail that is automatically generated when the group is formed or when a new member is added. The invited user must accept the invitation by return e-mail.

Having described the private network exchange with multiple service providers, having a portal, collaborative applications, and a directory service in accordance with the present invention, it is believed that other modifications, variations and changes will be suggested to those skilled in the art in view of the description set forth above. It is therefore to be understood that all such variations, modifications and changes are believed to fall within the scope of the invention as defined in the appended claims.

What is claimed is:

1. A directory service for a private network exchange having multiple service providers, comprising organizational, people, security, and place information for registered companies of the private network, said directory service being accessible to employees and applications in said companies.

2. A directory service as recited in claim 1, wherein said directory service resides solely in extranet space.

3. A directory service as recited in claim 1, wherein said directory service comprises information about said companies including company names, addresses, and industries.

4. A directory service as recited in claim 1, wherein said directory comprises information about registered users including user name, address, and affiliated company.

5. A directory service as recited in claim 1, wherein said directory service comprises a certificate governing what resources on the private network registered users can access.

6. A directory service as recited in claim 1, wherein users provided with a view of all resources available on the private network and can access only a subset of said resources.

7. A directory service as recited in claim 1, wherein users provided with a view of only resources that they are authorized to access.

8. A directory service as recited in claim 1, comprising a listing of individuals that can be sorted by geography, last name, first name, and zip code.
